(19) United States
(12) Patent Application Publication
(10) Pub. No.: US 2007/0217995 A1
(43) Pub. Date: Sep. 20, 2007

(54) Hydrogen Producing Method and Apparatus

(76) Inventors: Chi Matsumura, Fujisawa-shi (JP); Takahiro Oshita, Yokohama-shi (JP); Syuichi Ueno, Yokohama-shi (JP); Hideyuki Misawa, Yokohama-shi (JP); Masahiro Hagiwara, Yokohama-shi (JP); Itaru Shirasawa, Yotsukaido-shi (JP); Hiroshi Yokota, Yokohama-shi (JP); Akira Uchino, Koshigaya-shi (JP); Junichi Hayakawa, Yokohama-shi, Kanagawa (JP); Shinichi Isaka, Shinjuku-ku (JP)

Correspondence Address: WENDEROTH, LIND & PONACK, L.L.P., 2033 K STREET N. W., SUITE 800, WASHINGTON, DC, 20006-1021, US

(21) Appl. No.: 10/589,785

(22) PCT Filed: Feb. 17, 2005
(86) PCT No.: PCT/JP05/02417

§ 371 Date: Aug. 17, 2006

(30) Foreign Application Priority Data
Feb. 18, 2004 (JP) 2004-042019
Feb. 18, 2004 (JP) 2004-042021
Feb. 18, 2004 (JP) 2004-042022
Feb. 18, 2004 (JP) 2004-042024
Feb. 18, 2004 (JP) 2004-042043
Feb. 18, 2004 (JP) 2004-042044

(51) Int. Cl. C01B 3/00

(52) U.S. Cl. 423/657; 422/162

(57) ABSTRACT

A method for producing hydrogen wherein use is made of a high temperature steam electrolysis apparatus having an electrolysis vessel being partitioned into the anode side and the cathode side by the use of a solid oxide electrolyte film as a diaphragm, steam is fed to the above cathode side and a reducing gas is fed to the anode side, and steam electrolysis is carried out at a high temperature, characterized in that the reducing gas and the steam fed to the electrolysis vessel has a temperature of 200 to 500° C. The above temperature range for the reducing gas and the steam fed to the electrolysis vessel has been found to be an optimum temperature range, as a result of taking the heat balance within the vessel into consideration, in a high temperature steam electrolysis apparatus wherein a solid oxide electrolyte film is used, a reducing gas is fed to the anode side and steam is fed to the cathode side, an oxygen ion is allowed to react with said reducing gas on the cathode side, to thereby generate a concentration gradient for an oxygen ion and thus reduce an electrolysis voltage.

### TECHNICAL FIELD

The present invention relates to a method and apparatus for producing high-purity hydrogen by electrolyzing high-temperature steam.

### BACKGROUND ART

With a reducing gas having hydrogen and carbon monoxide as principal components thereof, the carbon monoxide can be hydrogenated by steam reforming, and then the hydrogen can be separated off and purified and used effectively in the chemical industry, as a fuel for fuel cells, or the like. However, with a polymer electrolyte fuel cell, which has recently come to be promising as technology that is close to becoming practicable, platinum is used as a catalyst, and hence the amount of carbon monoxide contained in the hydrogen fuel must be made to be virtually zero; gas reforming and purification for obtaining high-purity hydrogen are complicated, and hence there have been problems in terms of operability and economics. Moreover, with an electrolysis method using electrical power generated using pyrolysis gas, high-purity hydrogen can be obtained with a relatively simple configuration, but the electrical power consumption is very high. In contrast with these hydrogen producing methods, there is a high-temperature steam electrolysis method in which steam is electrolyzed at a high temperature of approximately 800° C., and thermal energy is used in the decomposition of the water, whereby the electrolysis voltage can be reduced and hence the electrical power for the electrolysis can be reduced. However, even with this method, at least 60% of the energy for decomposing the water must still be made up electrical power. As a proposal for improving this high-temperature steam electrolysis method, in U.S. Pat. No. 6,051,125, there is proposed a method in which natural gas is supplied to the anode of an electrolysis vessel, so as to reduce the electrolysis voltage required for movement of oxygen to the anode side; however, this method has the drawback that expensive natural gas is consumed, and moreover measures for preventing electrode soiling due to carbon deposited through reaction between the natural gas and oxygen are required, and hence there are problems in practice.

As means for solving these problems, the present inventors have previously focused on facts such as (1) pyrolysis gas from biomass such as waste wood or garbage is a reducing gas having hydrogen and carbon monoxide as principal components thereof, (2) by supplying a reducing gas as in (1) to the anode side of a high-temperature steam electrolysis vessel and reacting with oxygen ions on the anode side, the electrolysis voltage can be greatly reduced, and (3) in oxidation of a reducing gas as in (1) having hydrogen and carbon monoxide as principal components thereof, carbon is not deposited and hence there is no risk of electrode soiling, and have proposed a hydrogen manufacturing apparatus in which such a reducing gas is supplied to the anode side of a high-temperature steam electrolysis vessel so as to reduce the electrolysis voltage, and applied for a patent (Japanese Patent Application No. 2002-249754). With the invention proposed in that patent application, when producing hydrogen by electrolyzing steam using a high-temperature steam electrolysis vessel in which a solid oxide electrolyte is used as a diaphragm, and the diaphragm is disposed in the electrolysis vessel so as to partition the electrolysis vessel into an anode side and a cathode side, high-temperature steam is supplied to the cathode side of the electrolysis vessel, and a reducing gas is supplied to the anode side of the electrolysis vessel, thus reacting together oxygen ions and the reducing gas on the anode side of the electrolysis vessel, whereby an oxygen ion concentration gradient is produced, and hence the voltage required for movement of oxygen to the anode side is reduced. With this apparatus, through the steam being decomposed at a high temperature of 700 to 800° C., and the oxygen concentration gradient being produced on the anode side, high-purity hydrogen can be manufactured very efficiently.

### DISCLOSURE OF THE INVENTION

### Problems to be Solved by the Invention

It is an object of the present invention to study the thermal balance inside the electrolysis vessel of a high-temperature steam electrolysis apparatus as described above, so as to discover an optimum temperature for the supplied reducing gas and steam.

### MEANS FOR SOLVING THE PROBLEMS

In a high-temperature steam electrolysis vessel as described above, when a mixed gas of hydrogen gas and carbon monoxide is used as the reducing gas and supplied to the anode side of the electrolysis vessel, and steam electrolysis is carried out at a high temperature of 700 to 800° C., according to thermodynamic calculations electrical power is not required. However, in an actual electrolysis apparatus, there are an anode overpotential, a cathode overpotential, and resistance loss, and hence the actual situation is that practicable operation is not possible unless an overpotential of at least 0.5 V is applied. This overpotential acts as an energy source for maintaining the electrolysis cell at a high temperature as heat, but covers all of the heat carried out by the high-temperature gas discharged from the anode and the hydrogen produced at the cathode, and moreover produces steam from water, and is small compared with the energy for heating up to the electrolysis cell temperature.

When designing an actual apparatus, so that the design of a heat exchanger is made easy and the apparatus can be assembled with no difficulty, it is desirable to be able to use an auxiliary heat source. If a heat balance calculation is carried out for the inside of a steam electrolysis vessel, then it is found that if there is a heat source able to heat the steam, or produce the steam and then heat both the reducing gas and the steam to approximately 200 to 500° C., then energy balance can be achieved with the heat produced through an overpotential of at least 0.5 V.

That is, the present invention is a method of producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte membrane as a diaphragm, and carrying out steam electrolysis at high temperature, thus reacting oxygen ions on the anode side with the reducing gas so as to produce an oxygen ion concentration gradient and thus reduce the electrolysis voltage, the hydrogen producing method characterized in that the reducing gas and the steam supplied are made to have a temperature in a range of 200 to 500° C.

Note that “reducing gas” in the present invention means a gas that can react with oxygen that passes through the solid oxide electrolyte membrane in a steam electrolysis vessel to the anode side of the electrolysis vessel as described below so as to reduce the oxygen concentration on the anode side, and includes methane gas, pyrolysis gas from organic matter as described below, by-product gas from a coke oven, a blast furnace, a petroleum plant or the like, and so on.

### BRIEF DESCRIPTION OF THE DRAWINGS

FIG. 1 is a flow diagram of a hydrogen producing system using high-temperature steam electrolysis using the present invention;

FIG. 2 is a drawing showing the concept of a high-temperature steam electrolysis apparatus according to the present invention;

FIG. 3 is a flow diagram showing in outline a hydrogen producing system in which the present invention is applied to a pressurized water type nuclear power plant;

FIG. 4 is a flow diagram showing in outline a hydrogen producing system in which the present invention is applied to a fast breeder reactor type nuclear power plant;

FIG. 5 is a flow diagram showing in outline a hydrogen producing system in which the present invention is applied to a high-temperature gas type nuclear power plant;

FIG. 6 is a flow diagram showing in outline a boiling water type nuclear power system using the present invention;

FIG. 7 is a flow diagram showing the concept of a hydrogen producing system according to a mode of the present invention;

FIG. 8 is a flow diagram showing the concept of a hydrogen producing system according to another mode of the present invention;

FIG. 9 is a flow diagram showing the concept of a hydrogen producing system according to another mode of the present invention;

FIG. 10 is a flow diagram showing the concept of a hydrogen producing system according to another mode of the present invention;

FIG. 11 is a flow diagram showing the concept of a hydrogen producing system according to another mode of the present invention;

FIG. 12 is a flow diagram showing the concept of a hydrogen producing system according to another mode of the present invention;

FIG. 13 is a flow diagram showing the concept of a hydrogen producing system according to another mode of the present invention;

FIG. 14 is a flow diagram showing the concept of a hydrogen producing system according to another mode of the present invention;

FIG. 15 is a flow diagram showing the concept of a hydrogen producing system according to another mode of the present invention;

FIG. 16 is a flow diagram showing the concept of a hydrogen producing system according to another mode of the present invention;

FIG. 17 is a flow diagram of a hydrogen producing method according to a mode of the present invention;

FIG. 18 is a flow diagram of a hydrogen producing method according to another mode of the present invention;

FIG. 19 is a flow diagram of a hydrogen producing method according to another mode of the present invention;

FIG. 20 is a flow diagram of a power generation method according to another mode of the present invention;

FIG. 21 is a flow diagram of a power generation method according to another mode of the present invention;

FIG. 22 is a flow diagram of a hydrogen producing method according to a mode of the present invention;

FIG. 23 is a flow diagram of an experimental apparatus used in working examples of the present invention; and

FIG. 24 is a graph showing results for the working examples of the present invention.

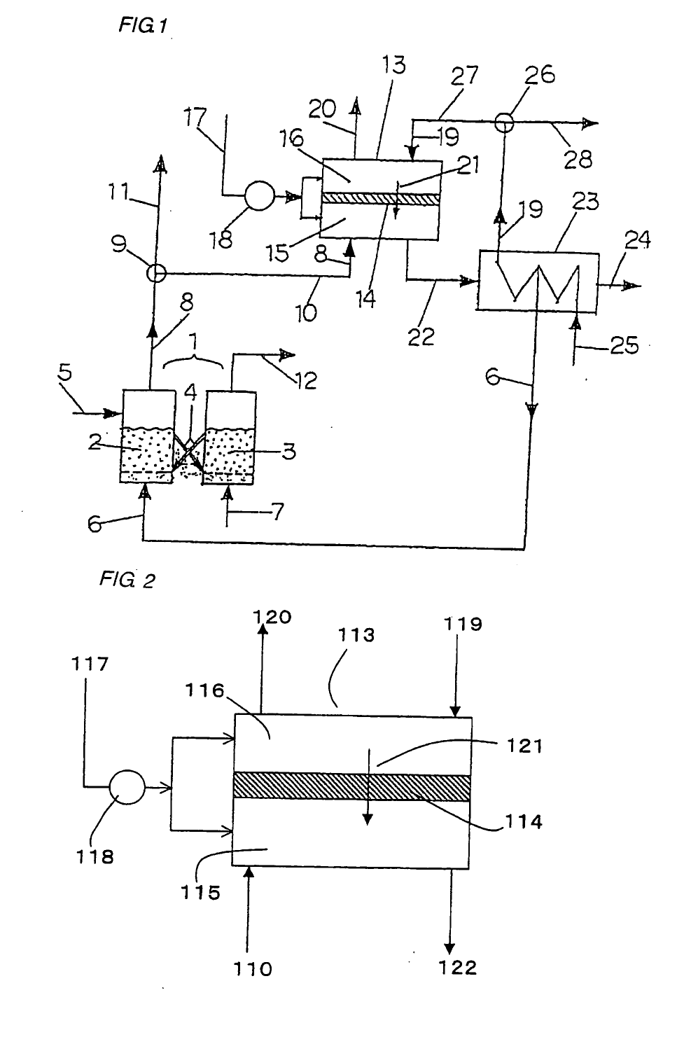

In FIG. 1, the reference numerals have the following meanings.
1 Pyrolysis furnace
2 Pyrolysis fluidized bed
3 Combustion fluidized bed
4 Heat transfer medium moving bed
5 Raw material
6 Steam
7 Air
8 Pyrolysis gas
9 Gas flow regulating valve
10, 11 Gas pipeline
12 Combustion exhaust gas
13 High-temperature steam electrolysis vessel
14 Solid oxide electrolyte diaphragm
15 Anode side
16 Cathode side
17 Electrical power
18 AC-DC converter
19 High-temperature steam
20 Hydrogen
21 Oxygen
22 High-temperature exhaust gas
23 Heat exchanger
24 Low-temperature exhaust gas
25 Pure water
26 Steam flow regulating valve
27, 28 Steam pipeline

FIG. 1 shows the basic principle of a hydrogen producing apparatus using high-temperature steam electrolysis using a solid oxide electrolyte membrane according to the present invention.

A high-temperature steam electrolysis vessel 13 is partitioned into an anode side 15 and a cathode side 16 by a solid oxide electrolyte diaphragm 14. High-temperature steam 19 is supplied to the cathode side 16 of the electrolysis vessel, a reducing gas 8 is supplied to the anode side 15 of the electrolysis vessel, and electrical power 17 is converted into DC by an AC-DC converter 18 and applied into the electrolysis vessel, whereupon the high-temperature steam 19 supplied to the cathode side 16 is decomposed into hydrogen and oxygen through electrolytic action. The hydrogen 20 produced is collected as high-purity hydrogen. On the other hand, the oxygen 21 produced passes selectively through the solid oxide electrolyte diaphragm 14, moving to the anode side 15 through the driving force of an overpotential. On the anode side 15, the oxygen 21 reacts with the reducing gas 8 and is thus consumed, whereby an oxygen ion concentration gradient is formed, and hence the voltage required for electrolyzing the water decreases, and thus the electrical power consumption is greatly reduced.

By introducing moisture (steam) into the reducing gas supplied to the anode side, deposition of carbon onto the electrode can be suppressed, and hence the lifetime of the apparatus can be increased.

The present inventors have studied the heat balance in such a high-temperature steam electrolysis vessel.

For example, in the case that methane gas is supplied to the anode side of the electrolysis vessel, the reactions on the anode side and the cathode side of the electrolysis vessel and the reaction heats are as in the following formulae.
Anode: CH₄+2O₂>CO₂+2H₂O: ΔH=−803 kJ
Cathode: 4H₂O→4H₂+2O₂: ΔH=+968 kJ Formula 1

The total heat balance of the reactions is thus 165 kJ endothermic, and hence heat must be supplied in from outside in principle.

Moreover, in the case that a gas having hydrogen and carbon monoxide as principal components thereof is supplied in, the reactions on the anode side and the cathode side of the electrolysis vessel are as in the following formulae.
Anode: 2H₂+O₂→2H₂O: ΔH=−484 kJ
2CO+O₂→2CO₂: ΔH=−566 kJ
Cathode: 4H₂O→4H₂+O₂: ΔH=+968 kJ Formula 2

The reactions are thus slightly exothermic in total (ΔH=−81 kJ), and hence heat need not be supplied in from outside in principle.

For the high-temperature steam electrolysis method using a solid oxide electrolyte membrane in which a reducing gas is supplied to the anode, upon carrying out thermodynamic analysis, it is found that electrical energy is hardly required, but in actual practice an anode overpotential, a cathode overpotential, and voltage consumed through the electrical resistance of the electrolyte are required. The overpotential must be made to be not more than 0.5 V for power saving.

The 0.5 V overpotential becomes heat, the amount of this heat being approximately 260 kJ in the case of electrolyzing 4 mols of water. In the case of supplying methane to the anode side of the electrolysis vessel, the heat generated due to this overpotential is thus used as energy for the endothermic reaction. However, the endothermicity of the reaction is 165 kJ as calculated above, and hence in total an energy of 260−165=95 kJ remains, this being used as surplus power that heats the supplied gas.

Next, let us consider how much the supplied gas can be heated by this energy of 95 kJ. In the case of supplying methane to the anode side of the electrolysis vessel, the heat capacity of methane is approximately 50 J/deg·mol, and hence the energy required in the case of raising the temperature of the methane by, for example, 400° C. is approximately 20 kJ/mol. Meanwhile, the steam supplied to the cathode side is used in four times the number of mols as the methane, and hence because the heat capacity of steam is approximately 37 J/mol, the energy required to raise the temperature of this steam by 400° C. is approximately 60 kJ. The total is thus approximately 80 kJ, and hence the above surplus energy of 95 kJ is able to heat the methane and the steam so as to raise the temperature thereof by 400° C. That is, if the reducing gas and the steam are supplied into the high-temperature steam electrolysis vessel according to the present invention at, for example, 400° C., then the reducing gas and the steam can be heated up to approximately 800° C. through the surplus energy due to the overpotential.

If the temperature of the reducing gas supplied to the anode side and the high-temperature steam supplied to the cathode side of the high-temperature steam electrolysis vessel is made to be in a range of 300 to 500° C., then by applying an overpotential of 0.5 V, the temperature in the electrolysis vessel can thus be made to be in a range of 700 to 900° C. through the heat produced due to the overpotential, and hence high-purity hydrogen can be manufactured efficiently through the high-temperature steam electrolysis.

Moreover, in the case of applying a higher overpotential, the rise in the temperature in the electrolysis vessel can be further increased, and hence the temperature of the reducing gas and the steam supplied into the electrolysis vessel can be further reduced. Considering practicability, according to the present invention, the temperature of the reducing gas supplied to the anode side and the temperature of the high-temperature steam supplied to the cathode side of the high-temperature steam electrolysis vessel are thus generally in a range of 200 to 500° C., more preferably 300 to 500° C., yet more preferably 350 to 450° C.

Regarding the thermal balance in the case of supplying a mixed gas of carbon monoxide and hydrogen as the reducing gas to the anode side of the electrolysis vessel, the heat balance can be studied as above; the heat balance is better than in the case of methane, and hence if, for example, the temperature of the reducing gas supplied to the anode side and the high-temperature steam supplied to the cathode side of the high-temperature steam electrolysis vessel is made to be in a range of 200 to 500° C., then by applying an overpotential of 0.5 V, the temperature in the electrolysis vessel can be made to be in a range of 700 to 1000° C. due to the heat produced by the overpotential, and hence high-purity hydrogen can be manufactured efficiently through the high-temperature steam electrolysis.

By measuring the temperature of the gas supplied to the anode side or the cathode side of the high-temperature steam electrolysis vessel using a measuring apparatus, and changing the value of the overpotential supplied in accordance with the measured temperature using a control apparatus, the temperature in the electrolysis vessel can be controlled to a desired temperature. That is, if the temperature of the supplied gas is relatively high, then the value of the overpotential can, for example, be reduced from 0.5 V so as to maintain the temperature in the electrolysis vessel in a range of 700 to 1000° C., whereas in the case that the temperature of the supplied gas is relatively low, the value of the overpotential can, for example, be increased from 0.5 V so as to maintain the temperature in the electrolysis vessel in a range of 700 to 1000° C.

Note that in the case of using a reducing gas produced through pyrolysis of organic matter as the reducing gas supplied to the anode side of the high-temperature steam electrolysis vessel, in principle the reaction is exothermic in total, but due to carbon dioxide, nitrogen and so on being contained as impurities, the situation is not necessarily advantageous compared to methane.

Note also that the above values are for the heat balance calculated without considering heat loss and so on, and hence in actual practice a little more heat may be required. However, for methane, the amount of heat required for heating is not large, and hence even in the case that the temperature of the methane is first set to normal temperature so that pre-treatment such as desulfurization can be carried out, there will be no great disadvantage. If anything, it is preferable to carry out such desulfurization with the temperature set to not more than 100° C.

A specific example of a hydrogen producing system using the present invention will now be described with reference to FIG. 1.

In FIG. 1, a pyrolysis furnace 1 is constituted from a pyrolysis fluidized bed 2 having steam 6 as a fluidizing gas, a combustion fluidized bed 3 having air 7 as a fluidizing gas, and a heat transfer medium moving bed 4. Raw material 5 with biomass such as waste wood or garbage as organic raw material is supplied into the pyrolysis fluidized bed 2 and pyrolyzed through heat from a heat transfer medium (sand), here being decomposed into a reducing pyrolysis gas 8 having hydrogen and carbon monoxide as principal components thereof and char. The char produced passes through the heat transfer medium moving bed 4 together with the heat transfer medium and is returned into the pyrolysis fluidized bed 2. Waste heat in combustion exhaust gas 12 discharged from the combustion fluidized bed 3 can be separately used. Moreover, as the fluidizing gas in the pyrolysis fluidized bed 2, instead of the steam 6, some of the pyrolysis gas 8 may be circulated back and used. The pyrolysis gas 8 produced is controlled so as to be distributed into gas pipelines 10 and 11 via a gas flow regulating valve 9, the gas in the pipeline 10 being supplied to the anode side 15 of the high-temperature steam electrolysis vessel 13, and the gas in the pipeline 11 being pooled into a gas storage tank (not shown) and used in gas engine power generation or the like.

The high-temperature steam electrolysis vessel 13 is partitioned by the solid oxide electrolyte diaphragm 14 into the anode side 15 and the cathode side 16. Upon the high-temperature steam 19 being supplied to the cathode side 16 of the electrolysis vessel, the reducing gas 8 being supplied to the anode side 15 of the electrolysis vessel, and the electrical power 17 being converted into DC by the AC-DC converter 18 and applied into the electrolysis vessel, the high-temperature steam 19 supplied to the cathode side 16 is decomposed into hydrogen and oxygen through electrolytic action.

The hydrogen 20 produced is collected as high-purity hydrogen. On the other hand, the oxygen 21 produced passes selectively through the solid oxide electrolyte diaphragm 14, moving to the anode side 15 through the driving force of the overpotential. On the anode side 15, the oxygen 21 reacts with the reducing gas 8 and is thus consumed, whereby an oxygen ion concentration gradient is formed, and hence the voltage required for the oxygen to move to the anode side decreases, and thus the electrical power consumption is greatly reduced.

High-temperature exhaust gas 22 produced on the anode side 15 passes through a heat exchanger 23, and is discharged out of the system as low-temperature exhaust gas 24. In the heat exchanger 23, water 25 is supplied in, so as to produce the steam 6. The produced steam 6 can be used as the fluidizing gas for the pyrolysis fluidized bed 2 as described above. Moreover, the high-temperature steam 19 is controlled so as to be distributed into pipelines 27 and 28 via a flow regulating valve 26. The high-temperature steam 19 in the pipeline 27 is supplied to the cathode side 16 of the high-temperature steam electrolysis vessel. The high-temperature steam in the pipeline 28 can be used in power generation or the like.

As the electrical power 17 required for the electrolysis, low-cost nighttime electrical power can be used, or electrical power generated in-house can be used, using for example gas engine power generation using surplus pyrolysis gas via the gas pipeline 11, or steam turbine power generation using surplus high-temperature steam via the pipeline 28. The amounts of the pyrolysis gas 8 and the high-temperature steam 19 supplied into the high-temperature steam electrolysis vessel 13 may be controlled automatically using the flow regulating valves 9 and 26 respectively such as to maintain operation at optimum conditions in view of maintaining the operating temperature (approximately 800° C.) of the electrolysis vessel 13, the amount of electrical power inputted, and the amount of hydrogen produced.

An invention according to claim 1 of the present application relates to a method of producing hydrogen by supplying a reducing gas to an anode side and steam to a cathode side of a high-temperature steam electrolysis vessel partitioned into the anode side and the cathode using a solid oxide electrolyte diaphragm, and reacting the reducing gas with oxygen ions on the anode side so as to produce an oxygen ion concentration gradient and thus reduce the electrolysis voltage as described above, the method characterized in that the supplied reducing gas and steam are made to have a temperature in a range of 200 to 500° C.

Moreover, an invention according to claim 2 is the method according to claim 1, characterized in that the reducing gas and the steam supplied into the electrolysis vessel are heated to a temperature in a range of 200 to 500° C. by carrying out heat exchange with high-temperature offgas and high-temperature hydrogen discharged from the electrolysis vessel. In this case, if steam at 200° C. is used, then the temperature of each of the reducing gas and the steam will be raised to in a range of 200 to 500° C., and hence heat balance can be achieved with an overpotential of at least 0.5 V.

Moreover, an invention according to claim 3 is the method according to claim 1, characterized in that the reducing gas and the steam supplied into the electrolysis vessel are heated to a temperature in a range of 200 to 500° C. by carrying out heat exchange with waste heat from another process. In this case, there is no need to use off-gas (discharged gas) from the electrolysis vessel in the heat exchange.

Moreover, an invention according to claim 4 is the method according to claim 1, characterized in that the reducing gas supplied into the electrolysis vessel is heated to a temperature in a range of 200 to 500° C. by adding high-temperature gas thereto. In this case, the concentration of the reducing gas supplied into the electrolysis vessel decreases, but there is a large advantage that a heat exchanger is not needed.

Moreover, an invention according to claim 5 is the method according to claim 1 or 4, characterized in that the reducing gas or mixed gas of the reducing gas and high-temperature gas, and the steam supplied into the electrolysis vessel are heated to a temperature in a range of 200 to 500° C. by carrying out heat exchange with high-temperature offgas and high-temperature hydrogen discharged from the electrolysis vessel. With this method, the desired temperature can be obtained easily through the heat exchange with the hydrogen, without the reducing gas being diluted much.

Moreover, an invention according to claim 6 is the method according to claim 1 or 4, characterized in that the supplied reducing gas or mixed gas of the reducing gas and high-temperature gas is heated to a temperature in a range of 200 to 500° C. by carrying out heat exchange with waste heat from another process. In the case that waste heat at 200 to 500° C. can be used, by heating the reducing gas and the steam using this waste heat, the desired increase in temperature can be achieved more easily than through heat exchange with off-gas from the electrolysis vessel.

Moreover, an invention according to claim 7 is the method according to any of claims 1 through 6, characterized by operating with an electrolysis voltage in a range of 20 to 40% of a required energy, this being by using the steam electrolysis method using the reducing gas with the overpotential kept down to approximately 0.5 V.

Moreover, an invention according to claim 8 is the method according to any of claims 1 through 7, characterized in that a concentration of hydrochloric acid and/or sulfur compounds in the supplied reducing gas is made to be not more than 10 ppm. A reducing gas produced by pyrolyzing organic matter or a reducing gas obtained through methane fermentation generally contains considerable amounts of corrosive gases such as hydrochloric acid and sulfur compounds; these are very harmful to steam electrolysis electrodes, and hence it is very desirable to remove these harmful components. For the reducing gas, unlike for the steam, there is no latent heat when a gas at normal temperature, and hence heating from normal temperature is easy.

Moreover, an invention according to claim 9 is the method according to any of claims 1 through 8, characterized in that the supplied reducing gas is a reducing gas produced through pyrolysis of organic matter, and is cleaned/de-dusted using a scrubber or the like. In this case, moisture gets into the reducing gas through wet de-dusting, but this moisture is used in a reforming reaction with carbon monoxide.

Moreover, an invention according to claim 10 is the method according to any of claims 1 through 8, characterized in that the supplied reducing gas is by-product gas produced by a coke oven or a blast furnace of an ironworks.

Moreover, an invention according to claim 11 is the method according to any of claims 1 through 8, characterized in that the supplied reducing gas is by-product gas from a petroleum plant.

Moreover, an invention according to claim 12 is the method according to claim 9, characterized in that the pyrolysis raw material organic matter is biomass such as waste wood or garbage, and petroleum residue.

Moreover, an invention according to claim 13 relates to an apparatus for implementing a method as described above, i.e. is a hydrogen producing apparatus comprising an electrolysis vessel partitioned into an anode side and a cathode side by a solid oxide electrolyte diaphragm, a pipeline supplying a reducing gas to the anode side of the electrolysis vessel, and a pipeline supplying steam to the cathode side of the electrolysis vessel, and characterized by further comprising means for heating the reducing gas and the steam supplied into the electrolysis vessel to a temperature in a range of 200 to 500° C.

Moreover, an invention according to claim 14 is the apparatus according to claim 13, characterized in that a flow control valve is provided in each of the gas pipeline supplying the reducing gas to the anode side of the electrolysis vessel, and the pipeline supplying the steam to the cathode side of the electrolysis vessel, so as to optimally control operating conditions.

Moreover, an invention according to claim 15 is the apparatus according to claim 14, characterized in that a temperature gauge is provided in a gas outlet line on the anode side and the cathode side of the electrolysis vessel, and the flow control valves are controlled so as to obtain a constant temperature.

According to the present invention, high-purity hydrogen that can be used as fuel for polymer electrolyte fuel cells can be manufactured economically from low-value biomass or the like through a method for which consumption of expensive utilities such as electrical power and town gas is suppressed, and the configuration is relatively simple and there are few operational problems.

Moreover, in a second mode of the present invention, there is provided a method of producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte membrane as a diaphragm, and carrying out steam electrolysis at high temperature, the method characterized in that some of steam from a nuclear power plant vapor generator is used directly as the steam supplied to the cathode side.

In contrast with primary energy such as fossil fuel such as coal and petroleum, uranium, and sunlight, electricity, gas, gasoline and so on that are obtained through conversion from primary energy are known as secondary energy; hydrogen, which does not exist alone (as H₂) on Earth, is also included under secondary energy.

Of primary energy, reserves of coal, petroleum and natural gas have been built up on Earth over thousands to millions of years, and in a sense can be said to be fixed solar energy, such primary energy being finite.

Since the Second World War, as primary energy has shifted from what was previously mainly coal to mainly easy-to-use petroleum, the amount of petroleum used has increased rapidly, and as a result current petroleum reserves are predicted to be 30 to 50 years' worth, and it is said that petroleum production will decrease after about 2010. In fact, petroleum is already getting heavier and the sulfur content is increasing, and hence the demand for hydrogen for lightening petroleum and carrying out deep desulfurization is increasing year by year.

Meanwhile, CO₂ emissions have risen rapidly since 1900, and as a result the CO₂ concentration in the atmosphere has increased from 280 ppm in 1800 to 360 ppm in 2000. The prevailing opinion is that this has caused an average 0.6° C. increase in temperature over the past century, and it has been pointed out that the average temperature may further increase by 1.4 to 5.8° C. by 2100.

In addition, emissions of SOₓ and NOₓ are a serious problem, and it is feared that emissions thereof from developing countries that are expected to undergo development rapidly in the future will increase. In any event, it should be appreciated that once degraded, the global environment will not easily return to its original state.

Under the COP3 Kyoto Protocol, there is thus incorporated as a target for Japan a 6% reduction in greenhouse gases between 2008 and 2012 taking 1990 as a base year. Approximately 88% of Japan's greenhouse gases is CO₂ originating from energy, with methane, CFC substitutes and so on only constituting a few percent. The increase in greenhouse gas emissions by 2010 as judged from current growth will be 8 to 9%, and hence reductions of 14 to 15% are required by then; taking absorption by forests according to the Kyoto mechanism as 3.7%, reductions of 10.3 to 11.3% are thus required in real terms. As well as improving efficiency through energy saving, cogeneration and so on, the Government is thus aiming to actively introduce new energy, having as a target making 3.2% of all primary energy be new energy by 2010.

Of secondary energy, electrical energy is easy to use so long as there is a well-provided power network, and moreover ignoring when the energy is produced, is clean energy in that no pollutants are discharged upon use; demand is set to increase gradually but surely in the future. The biggest drawback of electrical energy is that electrical energy cannot be stored. The current state of affairs is thus that electricity is generated in accordance with the amount used, and hence inordinately large facilities are required so as to be able to meet times of peak usage. Natural energy such as wind power and sunlight that is anticipated will be used in the future can only be obtained intermittently, and often does not match up with times of peak usage. So that these types of energy can be used effectively, a secondary energy that can be stored and transported is thus required.

Hydrogen can be stored and transported as a substance, and although not existing naturally can be manufactured through a relatively simple method; in particular, in the case of obtaining hydrogen by electrolyzing water, the raw material is inexhaustible. Moreover, after use, the hydrogen becomes water again so that the raw material can be replenished, and unlike with fossil fuels, this cycle is completed in a very short time period. In this way, hydrogen and electrical power are interchangeable with one another through an electrochemical system (electrolysis of water or a fuel cell), and can be said to constitute clean energy that can be obtained from any primary energy.

In this way, from the viewpoint of conserving finite fossil fuels and protecting the global environment, the goal of a hydrogen energy system is fundamentally achieved only through renewable energy, but difficult technical problems still remain for this, and it is said that at least 30 to 40 years will be required until realization of this. Until then, at least at the stage of extracting energy, hydrogen manufacture using nuclear energy, which does not depend on fossil fuels and for which there are hardly any greenhouse gas emissions, is close to the desired state, and is receiving attention from all quarters as technology enabling hydrogen to be manufactured in large amounts; studies are being carried out into hydrogen manufacture through direct decomposition of water by a thermochemical process, steam reforming of natural gas or the like, and so on using a high temperature gas-cooled reactor that can attain a high temperature close to 1000° C.

Amid this state of affairs, a method of producing hydrogen through an electrolysis method using electrical power generated using pyrolysis gas has been proposed. With this method, high-purity hydrogen can be obtained with a relatively simple configuration, but the electrical power consumption is very high. In contrast with such a hydrogen producing method, there has been proposed a high-temperature steam electrolysis method in which steam is electrolyzed at a high temperature of approximately 800° C., and thermal energy is used in the decomposition of the water, whereby the electrolysis voltage can be reduced and hence the electrical power for the electrolysis can be reduced. However, even with this method, at least 60% of the energy for decomposing the water must still be made up with electrical power. As a proposal for improving this high-temperature steam electrolysis method, in U.S. Pat. No. 6,051,125, there is proposed a method in which natural gas is supplied to the anode of an electrolysis vessel, so as to reduce the electrolysis voltage required for movement of oxygen to the anode side; however, this method has the drawback that expensive natural gas is consumed, and moreover measures for preventing electrode soiling due to carbon deposited through reaction between the natural gas and oxygen are required, and hence there are problems in practice.

As means for solving these problems, for a high-temperature steam electrolysis apparatus, focusing on facts such as (1) pyrolysis gas from biomass such as waste wood or garbage is a reducing gas having hydrogen and carbon monoxide as principal components thereof, (2) by supplying a reducing gas as in (1) to the anode side of a high-temperature steam electrolysis vessel and reacting with oxygen ions on the anode side, the electrolysis voltage can be greatly reduced, and (3) in oxidation of a reducing gas as in (1) having hydrogen and carbon monoxide as principal components thereof, carbon is not deposited and hence there is no risk of electrode soiling, there has been proposed a hydrogen producing apparatus in which such a reducing gas is supplied to the anode side of a high-temperature steam electrolysis vessel so as to reduce the electrolysis voltage (Japanese Patent Application No. 2002-249754). With the apparatus proposed in that patent application, when producing hydrogen by electrolyzing steam using a high-temperature steam electrolysis vessel in which a solid oxide electrolyte is used as a diaphragm, and the diaphragm is disposed in the electrolysis vessel so as to partition the electrolysis vessel into an anode side and a cathode side, high-temperature steam is supplied to the cathode side of the electrolysis vessel, and a reducing gas is supplied to the anode side of the electrolysis vessel, so as to carry out steam electrolysis at high temperature, whereby oxygen ions produced through the electrolysis of the steam on the cathode side of the electrolysis vessel pass through the solid oxide electrolyte and move to the anode side, and react there with the reducing gas, so that an oxygen ion concentration gradient is produced, whereby the voltage required for the movement of the oxygen to the anode side is reduced. With this apparatus, through the steam being decomposed at a high temperature of 700 to 800° C., and the oxygen concentration gradient being produced on the anode side, high-purity hydrogen can be manufactured very efficiently.

The high-temperature steam electrolysis method described above is a method in which oxygen on the anode side of the electrolysis vessel is removed by supplying the reducing gas to the anode side, and the steam must be decomposed at a high temperature of 700 to 800° C. or above. On the other hand, regarding the combination of high-temperature steam electrolysis with vapor produced from a vapor generator of a light water reactor, which is a principal type of reactor currently shouldering nuclear power generation, or a fast breeder reactor, which is expected to become practicable in the near future, the temperature range of the vapor obtained is lower than the 900 to 1000° C. for a high temperature gas-cooled reactor, being a maximum of approximately 300° C. for a light water reactor and a maximum of approximately 500° C. for a fast breeder reactor, and hence these have not necessarily been viewed as being targets for the vapor supply source for high-temperature steam electrolysis. This is because an electrolysis voltage of approximately 1.3 V is required for the high-temperature steam electrolysis method even when operating at 1000° C., and hence to obtain a significant difference compared with the 1.7 to 1.8 V for an alkali or solid polymer electrolysis method at around 100° C., operation at as high a temperature as possible has been presupposed.

However, the group of the present inventors has carried out assiduous studies into the heat balance of high-temperature steam electrolysis, and as a result has discovered that for a high-temperature steam electrolysis apparatus of a type in which a reducing gas is supplied to the anode side and high-temperature steam is supplied to the cathode side of an electrolysis vessel, even if the temperature of the supplied steam and reducing gas is in a range of 200 to 500° C., heating to 700 to 800° C. which is a desirable operating temperature for the high-temperature steam electrolysis is possible through the Joule heat due to an overpotential of approximately 0.5 V in the electrolysis vessel.

The second mode of the present invention has been accomplished after discovering, based on the above findings, that even for a light water reactor or fast breeder reactor for which only alkali or solid polymer electrolysis method hydrogen manufacture using self-generated electrical power has been considered to be close to being realistic hitherto, by using a high-temperature steam electrolysis apparatus of the type in which a reducing gas is supplied to the anode side and high-temperature steam is supplied to the cathode side of the electrolysis vessel, hydrogen can be manufactured with an electrical power consumption less than 30% of that for the alkali or solid polymer electrolysis method.

That is, the second mode of the present invention relates to a method of producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the high-purity hydrogen producing method characterized in that some of steam from a nuclear power plant vapor generator is used directly as the steam supplied to the cathode side.

Note that “reducing gas” in the present invention means a gas that can react with oxygen that passes through the solid oxide electrolyte membrane in the steam electrolysis vessel to the anode side of the electrolysis vessel as described below so as to reduce the oxygen concentration on the anode side, and includes methane gas, pyrolysis gas from biomass such as waste wood or garbage as described below, by-product gas from a coke oven, a blast furnace, a petroleum plant or the like, and so on.

The basic principle of the hydrogen producing apparatus using high-temperature steam electrolysis using a solid oxide electrolyte membrane according to the present invention will now be described again with reference to FIG. 2.

A high-temperature steam electrolysis vessel 113 is partitioned into an anode side 115 and a cathode side 116 by a solid oxide electrolyte diaphragm 114. High-temperature steam 119 is supplied to the cathode side 116 of the electrolysis vessel, a reducing gas 110 is supplied to the anode side 115 of the electrolysis vessel, and electrical power 117 is converted into DC by an AC-DC converter 118 and applied into the electrolysis vessel, whereupon the high-temperature steam 119 supplied to the cathode side 116 is decomposed into hydrogen and oxygen through electrolytic action. The hydrogen 120 produced is collected as high-purity hydrogen. On the other hand, the oxygen 121 produced passes selectively through the solid oxide electrolyte diaphragm 114, and moves to the anode side 115 through the driving force of an overpotential. On the anode side 115, the oxygen 121 reacts with the reducing gas 110 and is thus consumed, whereby an oxygen ion concentration gradient is formed, and hence the voltage required for the oxygen to move to the anode side decreases, and thus the electrical power consumption is greatly reduced.

As described above, the group of the present inventors has studied the heat balance in a high-temperature steam electrolysis vessel in a hydrogen manufacturing apparatus using high-temperature steam electrolysis using a solid oxide electrolyte membrane, and as a result has discovered that the temperature of the reducing gas and high-temperature steam supplied into the high-temperature steam electrolysis vessel can be set to a low temperature of approximately 200 to 500° C. According to the present invention, some of the vapor at 200 to 300° C. produced from a vapor generator of a pressurized water type nuclear power plant, some of the vapor at 300 to 500° C. produced from a vapor generator of a fast breeder reactor type nuclear power plant, or some of the vapor at 500 to 700° C. produced from a vapor generator of a high-temperature gas type nuclear power plant can thus be supplied directly as the steam supplied into the high-temperature steam electrolysis vessel.

Supplying some of the vapor from a nuclear power plant vapor generator directly into a high-temperature steam electrolysis vessel in this way has not been proposed in the prior art, and a high facility utilization ratio can be maintained by changing the amount of hydrogen manufactured in accordance with the electrical power demand, without changing the nuclear reactor output and maintaining the vapor temperature at as high a temperature as possible. In particular, in the case of a pressurized water type or fast breeder type nuclear power plant or the like, due to an indirect cycle in which heat produced by the nuclear reactor and removed by a primary coolant is subjected to heat exchange with secondary system light water in the vapor generator so as to produce the vapor, the produced vapor does not contain radioactive matter, and hence the hydrogen manufactured can be used not only as a heat source in the nuclear power plant, but can also be supplied to a general demand destination.

Meanwhile, the reducing gas supplied to the anode can be easily obtained by pyrolyzing waste wood or garbage generated in the local area, or biomass generated from the agriculture, forestry, or fishery industry which is relatively easily procurable with domestic nuclear power plant site conditions. Furthermore, it is also possible to use digestion gas from marine life growing at cooling water intakes.

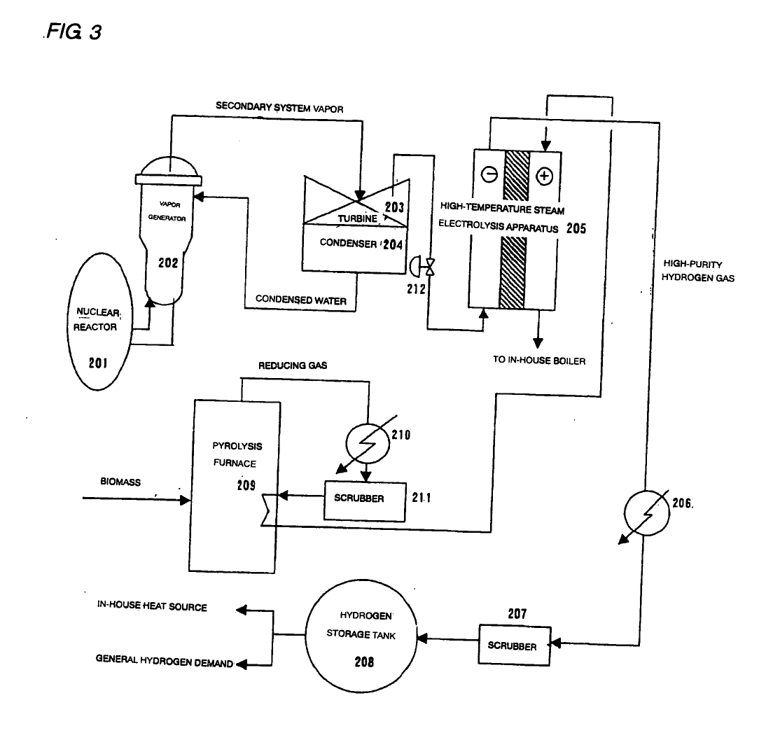

Next, a specific example of a hydrogen producing system in which the present invention is applied to a pressurized water type nuclear power plant will be described with reference to FIG. 3. In the following description, a specific example of operation is described, the present invention not being limited thereto.

In the system shown in FIG. 3, heated water heated to approximately 325° C. by nuclear fission in a nuclear reactor 201 passes through a primary system loop, is introduced into a vapor generator 202, and is subjected to heat exchange with a secondary system, before being returned into the nuclear reactor. Condensed water introduced into the secondary system of the vapor generator 202 turns into vapor at approximately 280° C., drives a turbine 203 so as to generate power, and is then cooled in a condenser 204 and thus turned back into condensed water, before being returned into the vapor generator 202.

Meanwhile, a high-temperature steam electrolysis apparatus 205 is an apparatus that uses a solid oxide electrolyte (stabilized zirconia etc.) as a diaphragm so as to partition an electrolysis vessel into an anode side and a cathode side, a reducing gas being supplied to the anode side and steam to the cathode side thereof, and oxygen ions on the anode side being reacted with the reducing gas, so as to produce an oxygen ion concentration gradient, whereby high-purity hydrogen can be manufactured with a lower electrolysis voltage than with a conventional method.

Vapor at 200 to 250° C. extracted from a high pressure side or a low pressure side of the turbine 203 is introduced to the cathode side of the high-temperature steam electrolysis apparatus 205, and oxygen ions are removed therefrom through the high-temperature steam electrolysis, so as to obtain high-purity hydrogen gas. The produced hydrogen gas is cooled by a cooler 206, impurities such as ammonia or hydrazine are removed therefrom by a scrubber 207, and then the hydrogen is stored in a hydrogen storage tank 208, and can then be used as an in-house heat source or for general hydrogen demand. Here, the condensed water system of the nuclear power plant contains ammonia, hydrazine or the like as a corrosion inhibitor, and hence this is vaporized and gets into the produced hydrogen, but by carrying out post-treatment as described above, high-purity hydrogen can be recovered. Note that through the above operation, the water supplied to the electrolysis apparatus 205 is removed from the secondary system vapor-condensed water system of the nuclear power plant, and hence a corresponding amount of water is preferably replenished into the secondary system vapor-condensed water system.

Moreover, it is possible to install a pyrolysis furnace 209 in the power plant, produce a reducing gas containing CO, methane and so on by pyrolyzing biomass such as waste wood or garbage collected in the power plant or from the surrounding local area, or marine life collected using a screen or the like at a water intake or from the fishery industry, cool this using a cooler 210, clean/de-dust using a scrubber 211, so as to reduce the concentration of hydrochloric acid and/or sulfuric acid compounds to not more than 10 ppm, and then reheat using the pyrolysis furnace 209, and introduce the reducing gas to the anode side of the high-temperature steam electrolysis apparatus 205.

The reducing gas introduced to the anode side of the electrolysis apparatus 205 undergoes chemical reaction with oxygen ions, to produce high-temperature waste gas containing unburnt matter, which can be supplied as an auxiliary fuel to an in-house boiler or the like.

The flow for the present apparatus is as described above; the operation of the apparatus can also be configured such that the flow rate of the vapor at 200 to 250° C. extracted from the high pressure side or the low pressure side of the turbine 203 is adjusted using a flow control valve 212 in accordance with fluctuations in the electrical power load of the power plant, whereby the amount of steam introduced to the cathode side of the high-temperature steam electrolysis apparatus 205 is controlled, so that the amount of hydrogen manufactured can be controlled efficiently. As a result, in the case, for example, that the electrical power demand has become low, surplus vapor can be used in the hydrogen manufacture, whereby the nuclear power plant can be operated efficiently.

According to the present invention, vapor from a pressurized water type nuclear power plant under low temperature conditions that could not be used in a conventional high-temperature steam electrolysis method can be used as is, and moreover biomass can be used effectively, and hence hydrogen can be manufactured at high purity efficiently.

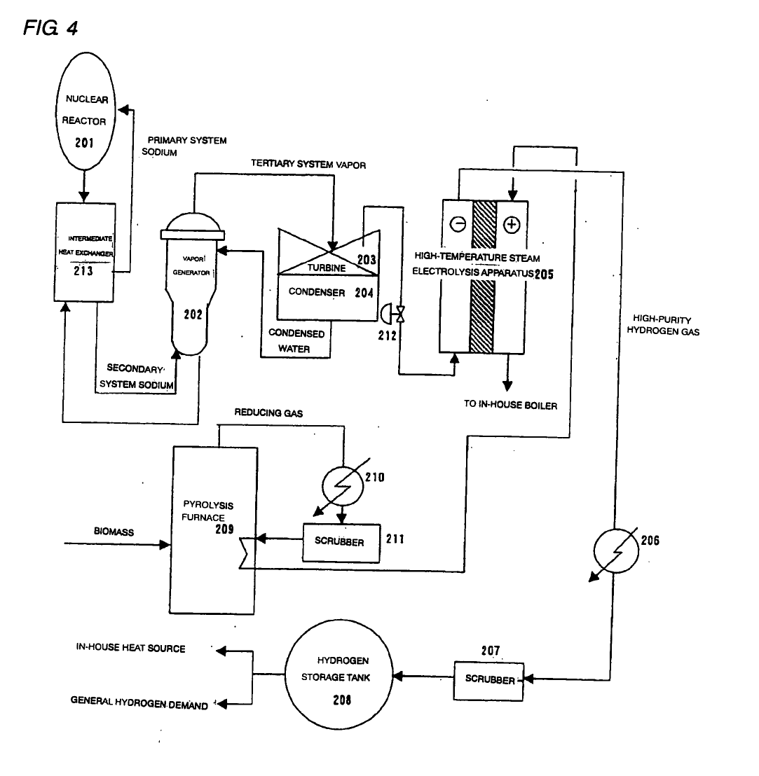

Moreover, as another example, a specific example of a hydrogen producing system in which the present invention is applied to a fast breeder type nuclear power plant will now be described with reference to FIG. 4. As above, in the following description, a specific example of operation is described, the present invention not being limited thereto. Moreover, description of constituent elements the same as ones in FIG. 3 will be omitted as appropriate.

In the system shown in FIG. 4, coolant sodium heated to approximately 530° C. by nuclear fission in a nuclear reactor 201 is introduced into an intermediate heat exchanger 213, and heat exchange is carried out, thus heating sodium in a secondary system loop to approximately 505° C. The secondary system sodium is introduced into a vapor generator 202 and subjected to heat exchange with tertiary system condensed water. Operation is carried out such that the sodium in each loop is circulated through the primary system or secondary system respectively.

The condensed water introduced into the tertiary system of the vapor generator 202 is subjected to heat exchange with the sodium so as to become vapor at approximately 480° C., drives a turbine 203 so as to generate power, and is then cooled in a condenser 204 and thus turned back into condensed water, before being returned into the vapor generator 202.

Meanwhile, a high-temperature steam electrolysis apparatus 205 is an apparatus that uses a solid oxide electrolyte (stabilized zirconia etc.), a reducing gas being supplied to the anode side and steam to the cathode side thereof, and oxygen ions on the anode side being reacted with the reducing gas, so as to produce an oxygen ion concentration gradient, whereby high-purity hydrogen can be manufactured with a lower electrolysis voltage than with a conventional method.

Vapor at 300 to 450° C. extracted from a high pressure side or a low pressure side of the turbine 203 is introduced to the cathode side of the high-temperature steam electrolysis apparatus 205, and oxygen ions are removed therefrom through the high-temperature steam electrolysis, so as to obtain high-purity hydrogen gas. This hydrogen gas is cooled by a cooler 206, impurities such as ammonia or hydrazine are removed therefrom by a scrubber 207, and then the hydrogen is stored in a hydrogen storage tank 208, and can then be used as an in-house heat source or for general hydrogen demand. Note that as for the system shown in FIG. 3, through the above operation, the water supplied to the electrolysis apparatus 205 is removed from the tertiary system vapor-condensed water system of the nuclear power plant, and hence a corresponding amount of water is preferably replenished into the tertiary system vapor-condensed water system.

Moreover, a pyrolysis furnace 209 installed in the power plant is a pyrolysis furnace using as a raw material biomass such as waste wood or garbage collected in the power plant or from the surrounding local area, or marine life collected using a screen or the like at a water intake or from the fishery industry; a reducing gas containing CO, methane and so on produced through pyrolysis in the pyrolysis furnace 209 is cooled using a cooler 210, cleaned/de-dusted using a scrubber 211, so as to reduce the concentration of hydrochloric acid and/or sulfuric acid compounds to not more than 10 ppm, and then reheated using the pyrolysis furnace 209, and introduced to the anode side of the high-temperature steam electrolysis apparatus 205.

The introduced reducing gas undergoes chemical reaction with oxygen ions, to produce high-temperature waste gas containing unburnt matter, which can be supplied as an auxiliary fuel to an in-house boiler or the like.

The flow for the present apparatus is as described above; the operation of the apparatus is also such that the flow rate of the vapor at 300 to 450° C. extracted from the high pressure side or the low pressure side of the turbine 203 is adjusted using a flow control valve 212 in accordance with fluctuations in the electrical power load of the power plant, whereby the amount of steam introduced to the cathode side of the high-temperature steam electrolysis apparatus 205 is controlled, so that the amount of hydrogen manufactured can be controlled efficiently.

According to the present invention, vapor from a fast breeder type nuclear power plant under low temperature conditions that could not be used in a conventional high-temperature steam electrolysis method can be used as is, and moreover biomass can be used effectively, and hence hydrogen can be manufactured at high purity efficiently.

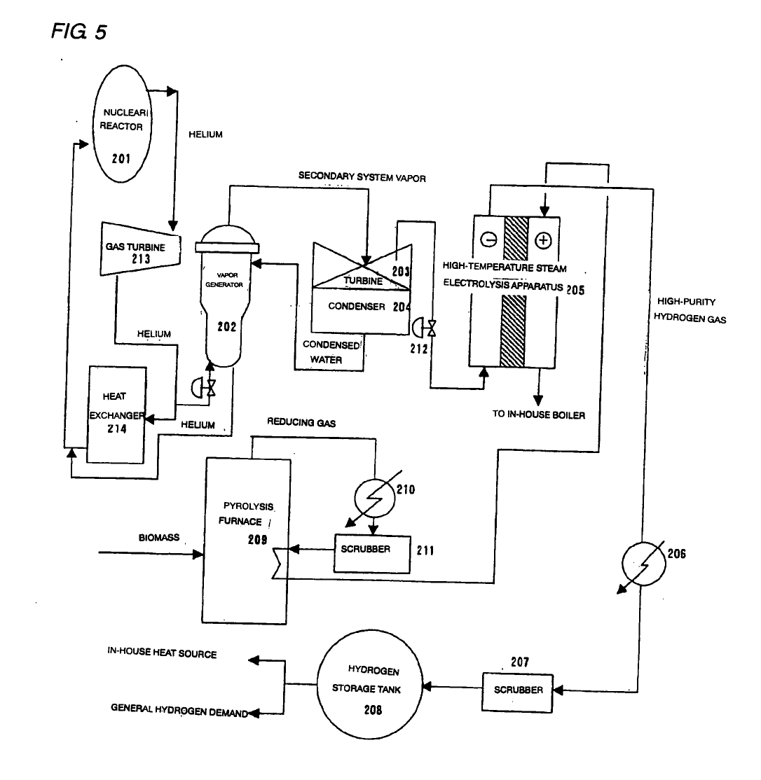

As yet another example, a specific example of a hydrogen producing system in which the present invention is applied to a high-temperature gas type nuclear power plant will now be described with reference to FIG. 5. As above, in the following description, a specific example of operation is described, the present invention not being limited thereto. Moreover, description of constituent elements the same as ones in FIGS. 3 and 4 will be omitted as appropriate.

In the system shown in FIG. 5, coolant helium heated to approximately 1000° C. by nuclear fission in a nuclear reactor 201 drives a gas turbine 213 directly so as to generate power, and is then introduced into a heat exchanger 214 and cooled, before being returned into the nuclear reactor. Some of the helium gas is withdrawn from this primary system helium loop either downstream or upstream of the gas turbine 213, and is introduced into a vapor generator 202 and subjected to heat exchange with secondary system condensed water. The helium gas discharged from the vapor generator 202 is merged back in downstream of the heat exchanger 214, and returned back into the nuclear reactor.

The condensed water introduced into the vapor generator 202 is subjected to heat exchange with the helium which is at approximately 700 to 900° C. so as to become vapor at approximately 600 to 750° C., drives a turbine 203 so as to generate power, and is then cooled in a condenser 204 and thus turned back into condensed water, before being returned into the vapor generator 202.

Meanwhile, a high-temperature steam electrolysis apparatus 205 is an apparatus that uses a solid oxide electrolyte (stabilized zirconia etc.), a reducing gas being supplied to the anode side and steam to the cathode side thereof, and oxygen ions on the anode side being reacted with the reducing gas, so as to produce an oxygen ion concentration gradient, whereby high-purity hydrogen can be manufactured with a lower electrolysis voltage than with a conventional method.

Vapor at 500 to 700° C. extracted from a high pressure side or a low pressure side of the turbine 203 is introduced to the cathode side of the high-temperature steam electrolysis apparatus 205, and oxygen ions are removed therefrom through the high-temperature steam electrolysis, so as to obtain high-purity hydrogen gas. This hydrogen gas is cooled by a cooler 206, impurities such as ammonia or hydrazine are removed therefrom by a scrubber 207, and then the hydrogen is stored in a hydrogen storage tank 208, and can then be used as an in-house heat source or for general hydrogen demand. Note that as for the system shown in FIG. 3, through the above operation, the water supplied to the electrolysis apparatus 205 is removed from the secondary system vapor-condensed water system of the nuclear power plant, and hence a corresponding amount of water is preferably replenished into the secondary system vapor-condensed water system.

Moreover, a pyrolysis furnace 209 installed in the power plant is a pyrolysis furnace using as a raw material biomass such as waste wood or garbage collected in the power plant or from the surrounding local area, or marine life collected using a screen or the like at a water intake or from the fishery industry; a reducing gas containing CO, methane and so on produced through pyrolysis in the pyrolysis furnace 209 is cooled using a cooler 210, cleaned/de-dusted using a scrubber 211, so as to reduce the concentration of hydrochloric acid and/or sulfuric acid compounds to not more than 10 ppm, and then reheated using the pyrolysis furnace 209, and introduced to the anode side of the high-temperature steam electrolysis apparatus 205.

The introduced reducing gas undergoes chemical reaction with oxygen ions, to produce high-temperature waste gas containing unburnt matter, which can be supplied as an auxiliary fuel to an in-house boiler or the like.

The flow for the present apparatus is as described above; the operation of the apparatus is also such that the flow rate of the vapor at 500 to 700° C. extracted from the high pressure side or the low pressure side of the turbine 203 is adjusted using a flow control valve 212 in accordance with fluctuations in the electrical power load of the power plant, whereby the amount of steam introduced to the cathode side of the high-temperature steam electrolysis apparatus 205 is controlled, so that the amount of hydrogen manufactured can be controlled efficiently.

According to the second mode of the present invention, vapor from a high-temperature gas type nuclear power plant under temperature conditions that could not be used directly in a conventional high-temperature steam electrolysis method can be used as is, and moreover biomass can be used effectively, and hence hydrogen can be manufactured at high purity efficiently.

Furthermore, according to a third mode of the present invention, there is provided a method of producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the high-purity hydrogen producing method characterized in that some of vapor from a nuclear reactor of a boiling water type nuclear power plant is used directly as the steam supplied to the cathode side. Vapor discharged from a boiling water type nuclear reactor, which is one of the principal types of reactor currently shouldering nuclear power generation, has a temperature range of 200 to 300° C., which is lower than the 900 to 1000° C. for a high temperature gas-cooled reactor, and hence as with steam from a nuclear power plant vapor generator, such vapor has not necessarily been viewed as being a target for the vapor supply source for high-temperature steam electrolysis.

However, as described above, the group of the present inventors has studied the heat balance in a high-temperature steam electrolysis vessel in a hydrogen producing apparatus using high-temperature steam electrolysis using a solid oxide electrolyte membrane as shown in FIG. 2, and as a result has discovered that the temperature of the reducing gas and high-temperature steam supplied into the high-temperature steam electrolysis vessel can be set to a low temperature of approximately 200 to 500° C. According to the present invention, some of the vapor at 200 to 300° C. produced by a boiling water type nuclear reactor can thus be supplied directly as the steam supplied into the high-temperature steam electrolysis vessel.

Supplying some of the vapor from a boiling water type nuclear reactor directly into a high-temperature steam electrolysis vessel in this way has not been proposed in the prior art, and a high facility utilization ratio can be maintained by changing the amount of hydrogen manufactured in accordance with the electrical power demand, without changing the nuclear reactor output and maintaining the vapor temperature at as high a temperature as possible.

Note that the vapor from a boiling water type nuclear reactor may contain trace amounts of radioactive isotopes such as ¹⁶N which has a half-life of 7.35 seconds. It is thus difficult to distribute the hydrogen manufactured through the present invention directly onto the general market. However, there are no restrictions on using the manufactured hydrogen as a hydrogen source or heat source required in a radiation controlled area in the nuclear power plant. Focusing on this point, in the present invention it has been discovered that hydrogen manufactured through high-temperature steam electrolysis using vapor from a boiling water type nuclear reactor can be injected into the primary cooling system as means for preventing stress corrosion cracking occurring in reactor internals, which is a problem characteristic to boiling water type nuclear reactors. As means for preventing such stress corrosion cracking occurring in reactor internals in a boiling water type nuclear reactor, in treatment of injecting hydrogen into the primary cooling system, the hydrogen must be injected in continuously at approximately 140 Nm³/h for a 1.1 GW nuclear power plant; conventionally, the hydrogen used has been hydrogen manufactured through conventional water electrolysis using in-house electrical power, or hydrogen supplied as compressed hydrogen from outside, and in the case of the latter in particular, the hydrogen is very expensive, the unit price being at least ¥100 per Nm³, and hence the cost is high, and moreover there has been risk from the perspective of stable supply. However, according to the present invention, hydrogen manufactured efficiently and stably through the method described above can be used, and hence the cost can be reduced, and the nuclear reactor can be operated stably.

Moreover, the reducing gas supplied to the anode can be easily obtained by pyrolyzing waste wood or garbage generated in the local area, or biomass generated from the agriculture, forestry, or fishery industry which is relatively easily procurable with domestic nuclear power plant site conditions. Furthermore, it is also possible to use digestion gas from marine life growing at cooling water intakes.

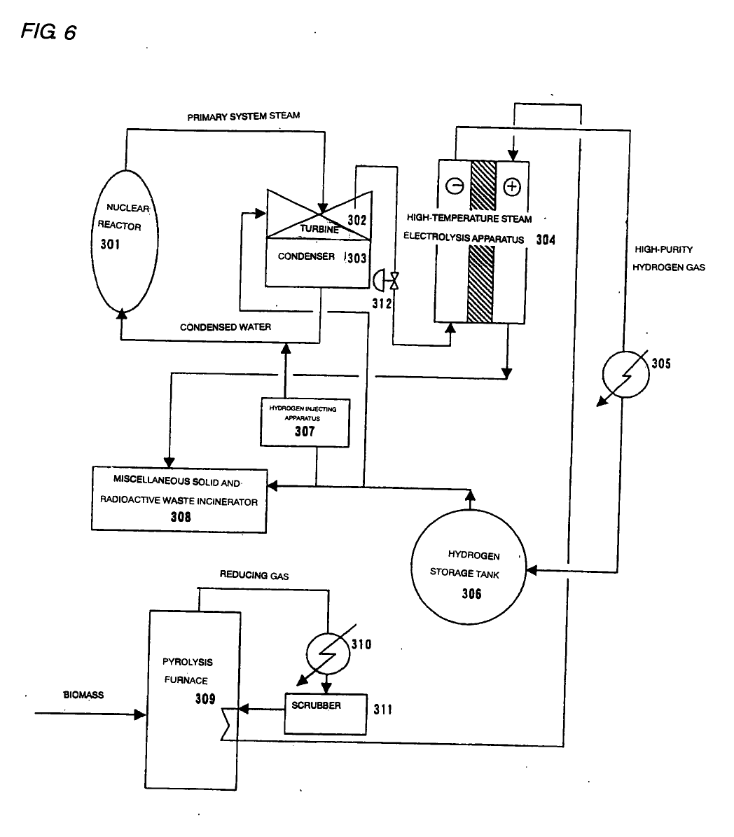

Next, a specific example of a hydrogen producing system in which the present invention is applied to a boiling water type nuclear power plant will be described with reference to FIG. 6. In the following description, a specific example of operation is described, the present invention not being limited thereto.

In the system shown in FIG. 6, primary system steam at approximately 270° C. produced from reactor water boiled by nuclear fission in a nuclear reactor 301 drives a turbine 302 so as to generate power, and is then cooled in a condenser 303 and thus turned back into condensed water, before being returned into the nuclear reactor 301.

Meanwhile, a high-temperature steam electrolysis apparatus 304 is an apparatus that uses a solid oxide electrolyte (stabilized zirconia etc.) as a diaphragm so as to partition an electrolysis vessel into an anode side and a cathode side, a reducing gas being supplied to the anode side and steam to the cathode side thereof, and oxygen ions on the anode side being reacted with the reducing gas, so as to produce an oxygen ion concentration gradient, whereby high-purity hydrogen can be manufactured with a lower electrolysis voltage than with a conventional method.

Vapor at 200 to 250° C. extracted from a high pressure side or a low pressure side of the turbine 302 is introduced to the cathode side of the high-temperature steam electrolysis apparatus 304, and oxygen ions are removed therefrom through the high-temperature steam electrolysis, whereby high-purity hydrogen gas is produced. The produced hydrogen gas is cooled by a cooler 305, and stored in a hydrogen storage tank 306 installed in a radiation controlled area. The stored hydrogen can be injected continuously into the condensed water system by a hydrogen injecting apparatus 307 as means for preventing stress corrosion cracking of reactor internals in the boiling water type nuclear reactor. Moreover, the stored hydrogen can also be supplied into a miscellaneous solid and radioactive waste incinerator 308 as fuel for incinerating miscellaneous radioactive solids. Furthermore, the stored hydrogen can also be supplied into the turbine 302 as a stator coolant for the generator. Note that through the above operation, the water supplied to the electrolysis apparatus 304 is removed from the primary system vapor-condensed water system of the nuclear power plant, and hence a corresponding amount of water is preferably replenished into the primary system vapor-condensed water system.

Moreover, it is possible to install a pyrolysis furnace 309 in the power plant, produce a reducing gas containing CO, methane and so on by pyrolyzing biomass such as waste wood or garbage collected in the power plant or from the surrounding local area, or marine life collected using a screen or the like at a water intake or from the fishery industry, cool this using a cooler 310, clean/de-dust using a scrubber 311, so as to reduce the concentration of hydrochloric acid and/or sulfuric acid compounds to not more than 10 ppm, and then reheat using the pyrolysis furnace 309, and introduce the reducing gas to the anode side of the high-temperature steam electrolysis apparatus 304.

The reducing gas introduced into the electrolysis apparatus 304 undergoes chemical reaction with oxygen ions, to produce high-temperature waste gas containing unburnt matter, which can be supplied as an auxiliary fuel to the miscellaneous solid and radioactive waste incinerator 308.

The flow for the present apparatus is as described above; the operation of the apparatus can also be configured such that the flow rate of the vapor at 200 to 250° C. extracted from the high pressure side or the low pressure side of the turbine 303 is adjusted using a flow control valve 312 in accordance with fluctuations in the electrical power load of the power plant, whereby the amount of steam introduced to the cathode side of the high-temperature steam electrolysis apparatus 304 is controlled, so that the amount of hydrogen manufactured can be controlled efficiently. As a result, in the case, for example, that the electrical power demand has become low, surplus vapor can be used in the hydrogen manufacture, whereby the nuclear power plant can be operated efficiently.

The third mode of the present invention relates to art according to which vapor from a boiling water type nuclear power plant under low temperature conditions that could not be used in a conventional high-temperature steam electrolysis method can be used as is, and moreover biomass can be used effectively, and hence hydrogen can be manufactured at high purity efficiently. Furthermore, the manufactured hydrogen gas can be injected continuously into a condensed water system by a hydrogen injecting apparatus 307 as means for preventing stress corrosion cracking of reactor internals in the boiling water type nuclear reactor, and hence the operating cost can be reduced, and the nuclear reactor can be operated stably.

Moreover, according to a fourth mode of the present invention, there is provided a system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the hydrogen producing system characterized by having means for heating at least one of the reducing gas supplied to the anode side and the steam supplied to the cathode side.

In the high-temperature steam electrolysis method of the type described above in which a reducing gas is supplied to the anode side of an electrolysis vessel, a reduction in the voltage required for electrolyzing the steam can be realized through thermal energy and an oxygen concentration gradient formed by the reducing gas. Heating the reducing gas and steam supplied into the electrolysis vessel to a desired temperature efficiently is thus important from the viewpoint of energy efficiency. Furthermore, exhaust gas and hydrogen-containing gas discharged from the electrolysis vessel are each discharged in a high-temperature state, and hence effectively using the thermal energy possessed by the discharged gas system is also important from the viewpoint of energy efficiency.

It is an object of the fourth mode of the present invention to realize effective use of thermal energy in the case of a hydrogen producing system using a hydrogen producing apparatus having a configuration as described above in which a reducing gas is supplied to the anode side of a high-temperature steam electrolysis vessel in which a solid oxide electrolyte is used.

As means for solving the above problem, the fourth mode of the present invention relates to a system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the hydrogen producing system characterized by having means for heating at least one of the reducing gas supplied to the anode side and the steam supplied to the cathode side.

Moreover, the fourth mode of the present invention relates to a system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the hydrogen producing system characterized by having means for recovering heat from at least one of high-temperature exhaust gas discharged from the anode side and high-temperature hydrogen-containing gas discharged from the cathode side of the high-temperature steam electrolysis apparatus.

Furthermore, the fourth mode of the present invention relates to a system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the hydrogen producing system characterized by having means for recovering heat from at least one of high-temperature exhaust gas discharged from the anode side and high-temperature hydrogen-containing gas discharged from the cathode side of the high-temperature steam electrolysis apparatus, and means for heating at least one of the reducing gas supplied to the anode side and the steam supplied to the cathode side of the high-temperature steam electrolysis apparatus using the recovered heat.

Furthermore, the fourth mode of the present invention relates to a system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte, and carrying out steam electrolysis at high temperature, the hydrogen producing system characterized by having means for adjusting the temperature of at least one of the reducing gas supplied to the anode side and the steam supplied to the cathode side of the high-temperature steam electrolysis apparatus, and recovering heat from at least one of high-temperature exhaust gas discharged from the anode side and high-temperature hydrogen-containing gas discharged from the cathode side of the high-temperature steam electrolysis apparatus.

In the above, “a system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature” is, in other words, a system that has an electrolysis vessel partitioned into an anode side and a cathode side by a solid oxide electrolyte diaphragm, a pipeline supplying a reducing gas to the anode side of the electrolysis vessel, and a pipeline supplying steam to the cathode side of the electrolysis vessel, wherein hydrogen is manufactured by electrolyzing the high-temperature steam on the cathode side of the electrolysis vessel by applying electrical power to the anode and the cathode, and oxygen on the anode side is reacted with the reducing gas so as to produce an oxygen concentration gradient whereby the electrolysis voltage is reduced.

Note that “reducing gas” in the present invention means a gas that can react with oxygen that passes through the solid oxide electrolyte membrane in the steam electrolysis vessel to the anode side of the electrolysis vessel as described below so as to reduce the oxygen concentration on the anode side, and includes methane gas, (e.g. a sewage treatment plant), COG gas discharged from an ironworks blast furnace, pyrolysis gas from waste wood, garbage, biomass or the like, by-product gas from a coke oven, a blast furnace, a petroleum plant or the like, and so on.

It is an object of the fourth mode to realize effective use of thermal energy in the case of a hydrogen producing system using a hydrogen producing apparatus as described with reference to FIG. 2 in which an electrolysis vessel partitioned into an anode side and a cathode side by a solid oxide electrolyte diaphragm is used, a reducing gas is supplied to the anode side and high-temperature steam is supplied to the cathode side of the electrolysis vessel, and electrical power is supplied to the anode and the cathode, so as to electrolyze the steam on the cathode side of the electrolysis vessel.

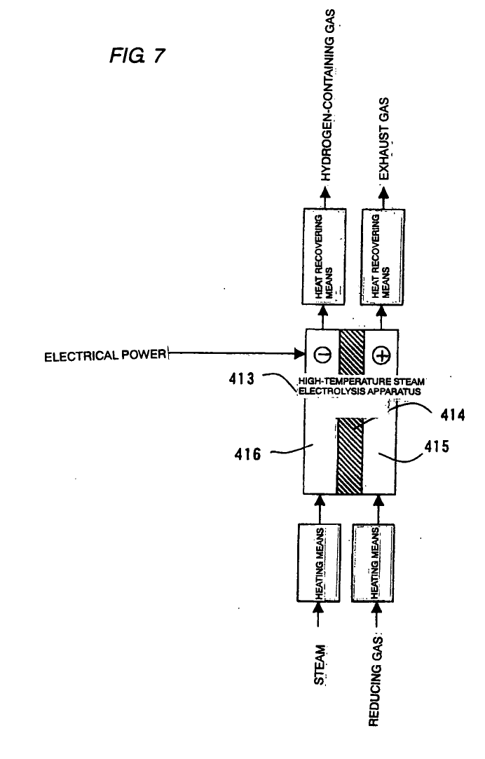

The concept of a hydrogen producing system according to a mode of the present invention is shown as a flow diagram in FIG. 7. A reducing gas is supplied to the anode side and high-temperature steam is supplied to the cathode side of a high-temperature steam electrolysis apparatus (or vessel) 413 partitioned into an anode side 415 and a cathode side 416 by a solid oxide electrolyte diaphragm 414, and electrical power is applied so as to electrolyze the steam, whereby hydrogen-containing gas is produced from the cathode side and exhaust gas is produced from the anode side. The hydrogen producing system according to this mode of the present invention has means for heating at least one of the reducing gas supplied to the anode side and the steam supplied to the cathode side. As a result, the reducing gas and/or the steam can be supplied heated to a required temperature for the high-temperature steam electrolysis. Moreover, a hydrogen producing system according to another mode of the present invention has means for recovering heat from at least one of the hydrogen-containing gas produced from the cathode side and the exhaust gas produced from the anode side of the electrolysis vessel. High-temperature hydrogen-containing gas and exhaust gas at 700 to 800° C. are produced from the high-temperature steam electrolysis vessel. By recovering and using heat possessed by these discharged gases, waste heat can thus be used effectively.

Note that deposition of carbon onto the anode can be suppressed by introducing moisture (steam) into the reducing gas supplied to the anode side of the high-temperature steam electrolysis apparatus.

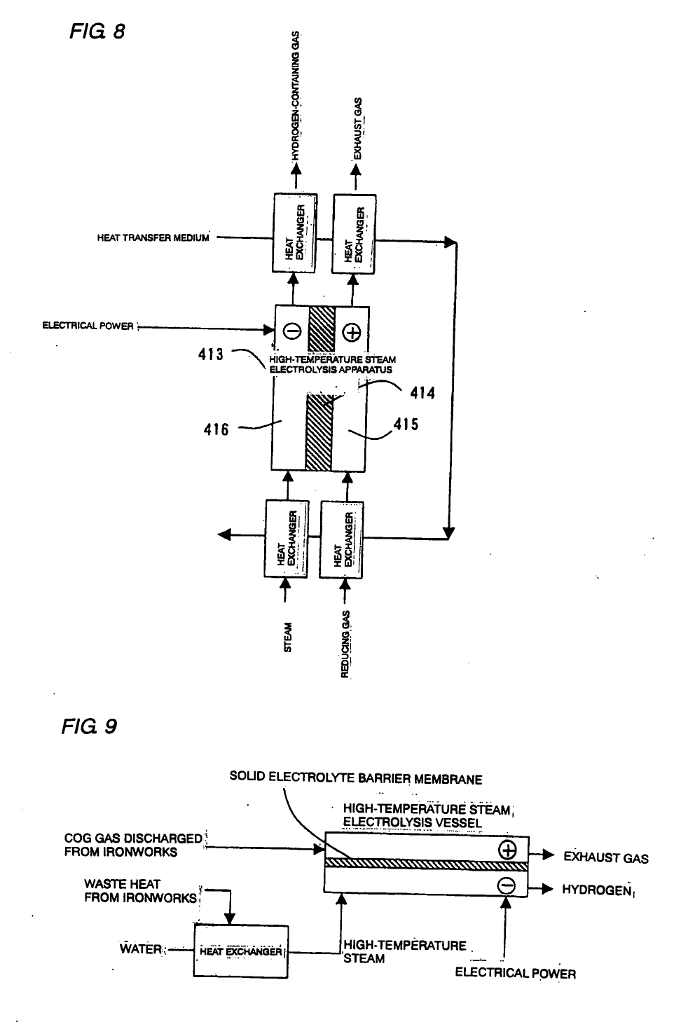

Moreover, the concept of a hydrogen producing system according to another mode of the present invention is shown as a flow diagram in FIG. 8. In the system shown in FIG. 8, heat is recovered using a heat exchanger and a heat transfer medium (e.g. air) from at least one of the high-temperature hydrogen-containing gas and exhaust gas produced from the steam electrolysis vessel, and the recovered heat is used as a heat source that is supplied to a heat exchanger for heating at least one of the steam and the reducing gas supplied into the electrolysis vessel. As a result, waste heat from the electrolysis vessel can be used effectively for heating the reducing gas and the steam supplied into the electrolysis vessel, and hence thermal energy can be used effectively.

Note that in the case that a very high-temperature gas such as blast furnace exhaust gas is used as the reducing gas supplied into the electrolysis vessel, it is preferable to conversely adjust the temperature to a suitable temperature for supply into the electrolysis vessel before supplying the reducing gas into the electrolysis vessel.

In a hydrogen producing system of the present invention, as a heat source required to produce the steam supplied into the electrolysis vessel, and a heat source required to heat the steam and the reducing gas, heat from any of various waste treatment facilities, a power plant, a heat utilizing facility, a facility using heat from high-temperature wastewater, e.g. a city infrastructure facility, or an industrial furnace, heat from a plant, heat produced from a coal mine facility, or heat discharged from a home, a shop or the like can be used. Here, examples of waste treatment facilities include incinerators, gasification-melting furnaces, gasification furnaces, RDF facilities, RPF facilities, treatment facilities for waste plastic or the like, and so on. Examples of power plants are power generating facilities such as thermoelectric power plants, geothermal power plants, hydroelectric power plants, medium/small hydroelectric power plants, solar power plants, wind power plants, waste power plants, power plants using biomass as a raw material, and fuel cell power plants. Examples of heat utilizing facilities include facilities utilizing, for example, solar heat, biomass heat, fuel cell waste heat, or supercritical heat, facilities utilizing waste heat from engines such as gas turbines, gas engines, gasoline engines, diesel engines, or Stirling engines, and facilities utilizing geothermal heat. Examples of city infrastructure facilities include water treatment facilities such as supplied water treatment facilities, intermediate water treatment facilities, and sewage treatment facilities, gas supply facilities such as gas producing/storage plants and gas transport facilities, and pipeline facilities for petroleum, gas, or liquefied gas. Examples of industrial furnaces include, for example, various furnaces in ironworks, coke ovens, cement furnaces, ceramic kilns, various heating/baking furnaces, various drying furnaces, coal gas furnaces, and high performance industrial furnaces. Examples of plants include petroleum, petrifaction and chemical plants and industrial complexes, paper mills, gas field facilities, and geothermal facilities. Examples of coal mine facilities include coal mines for coal and so on.

Moreover, in a hydrogen producing system of the present invention, steam produced from any of various facilities as above can be used as the steam supplied into the electrolysis vessel. For example, high-temperature steam is discharged from the above-mentioned waste treatment facilities, thermoelectric power plants, geothermal power plants, waste power plants, power plants using biomass as a raw material, fuel cell power plants and so on, city infrastructure facilities, various industrial furnaces, plants, and so on. Such waste steam can be used as a steam source supplied into a high-temperature steam electrolysis apparatus used in the hydrogen producing system according to the present invention.

Next, various forms of the hydrogen producing system according to the present invention will be described with reference to the drawings.

FIG. 9 shows a specific example in which, using a hydrogen producing system according to the present invention, hydrogen gas for fuel cells is manufactured using exhaust gas from an ironworks, e.g. coke oven gas, as the reducing gas supplied to the anode side of the electrolysis vessel.

High-temperature gas by-produced in the ironworks, e.g. COG gas from a coke oven, is taken as a raw material for the reducing gas supplied into the high-temperature steam electrolysis apparatus described earlier, and high-temperature steam is manufactured from water using a heat exchanger using waste heat produced from various sites in the ironworks, and this high-temperature steam is used as the high-temperature steam supplied into the high-temperature steam electrolysis apparatus, whereby high-purity hydrogen can be manufactured.

Note that as the electrical power supplied to the hydrogen producing apparatus, electrical power from general mains may be used, or electrical power generated by power generating equipment in the ironworks may be used.

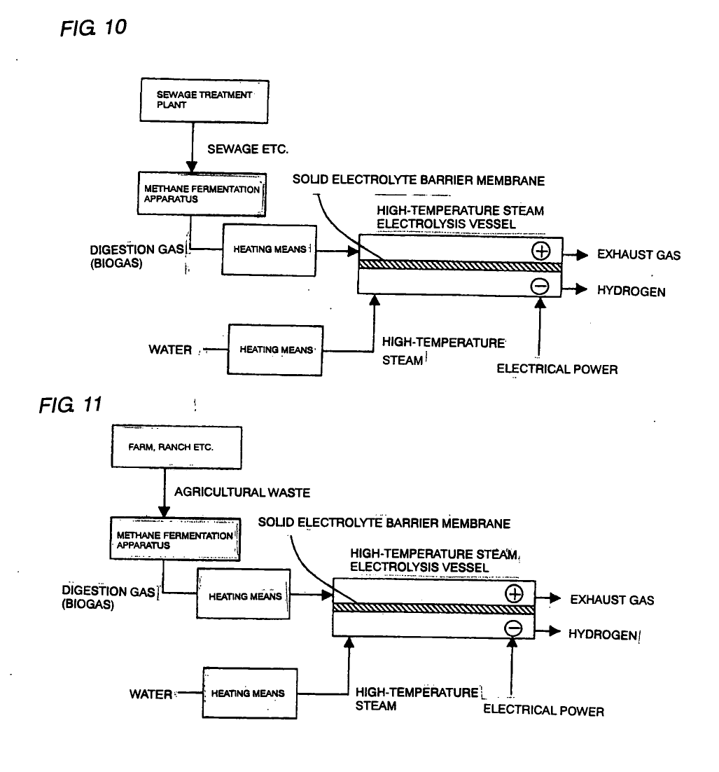

FIG. 10 shows a specific example in which, using a hydrogen producing system according to the present invention, digestion gas produced from a sewage treatment plant is used as the reducing gas, and the high-temperature steam is manufactured using waste heat from a waste incineration plant that is, for example, adjacent to the sewage treatment plant, whereby hydrogen gas for fuel cells is manufactured.

In the sewage treatment plant, there is installed a methane fermentation treatment apparatus for sewage or the like, and digestion gas (biogas) having methane as a principal component thereof is produced here. This biogas can be heated using heating means, and used as the reducing gas supplied into the high-temperature steam electrolysis apparatus according to the present invention. Meanwhile, high-temperature steam manufactured using heating means using waste heat from the sewage treatment plant or high-temperature steam supplied from outside is supplied into the high-temperature steam electrolysis apparatus, whereby high-purity hydrogen for fuel cells is manufactured.

Note that the high-temperature steam can be manufactured from water using heating means using waste heat from a waste incineration plant that is, for example, adjacent to the sewage treatment plant. In this case, the waste heat from the waste incineration plant supplied may also be used as a heating source for the methane fermentation apparatus.

Moreover, heat generated during the methane fermentation can be used as a heating source for the digestion gas and/or the steam or as a heat source for producing the steam. Note that the electrical power supplied to the high-temperature steam electrolysis apparatus may be electrical power from general mains, or electrical power generated by power generating equipment in the sewage treatment plant may be used.

FIG. 11 shows a specific example in which, using a hydrogen producing system according to the present invention, digestion gas (fermented methane gas) produced through methane fermentation treatment of agricultural waste from a farm, a ranch or the like is heated using heating means and then supplied into the high-temperature steam electrolysis apparatus as the reducing gas, whereby hydrogen for fuel cells is manufactured.

The agricultural waste from the farm, ranch or the like is treated using a methane fermentation apparatus, so as to produce digestion gas (biogas) comprising mainly methane gas. This is taken as the reducing gas, heated to an appropriate temperature using heating means, and then supplied into the high-temperature steam electrolysis apparatus. Meanwhile, high-temperature steam is supplied into the high-temperature steam electrolysis apparatus, whereby high-purity hydrogen for fuel cells is manufactured.

Note that the high-temperature steam may be produced and/or heated using heat produced by the methane fermentation apparatus as a heat source, or some of high-temperature steam supplied from outside may be used as a reaction heat source for the methane fermentation apparatus.

Note also that as the electrical power supplied to the hydrogen producing apparatus, general electrical power may be used, or electrical power generated on the farm or ranch may be used.

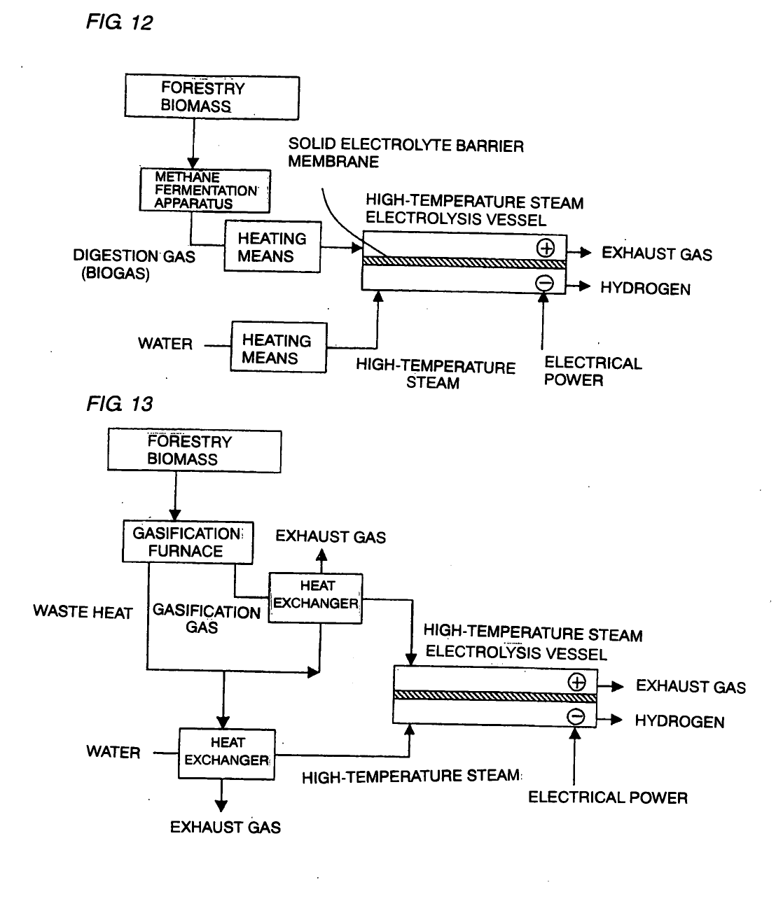

FIG. 12 shows a specific example in which, using a hydrogen producing system according to the present invention, digestion gas (fermented methane gas) produced by carrying out fermentation treatment on forestry waste (forestry biomass) discharged from forestry-related industry is supplied into the high-temperature steam electrolysis apparatus as the reducing gas, and hydrogen for fuel cells is manufactured.

The forestry waste (forestry biomass) discharged from the forestry-related industry is treated using a methane fermentation apparatus, whereby digestion gas (biogas) having methane gas as a principal component thereof is manufactured. The manufactured biogas is heated using heating means, and supplied into the high-temperature steam electrolysis apparatus as the high-temperature reducing gas. Meanwhile, high-temperature steam from outside is supplied into the high-temperature steam electrolysis apparatus, whereby high-purity hydrogen for fuel cells is manufactured.

Note that for the high-temperature steam, heat produced by the methane fermentation apparatus may be used as a heat source, or some of high-temperature steam supplied from outside may be used as a reaction heat source for the methane fermentation apparatus.

Note also that as the electrical power supplied to the hydrogen producing apparatus, general electrical power may be used, or electrical power generated in the forest or the like in question may be used.

FIG. 13 shows a specific example in which, using a hydrogen producing system according to the present invention, forestry waste (forestry biomass) discharged from forestry-related industry is treated in a gasification furnace to manufacture gasification gas, the manufactured gasification gas is taken as the reducing gas, the reducing gas is heated using a heat exchanger using waste heat produced from the gasification furnace and then supplied into the high-temperature steam electrolysis apparatus, and hydrogen for fuel cells is manufactured.

Taking the forestry biomass discharged from the forestry-related industry as a raw material, gasification gas having methane and carbon monoxide as principal components thereof is manufactured using the gasification furnace. The manufactured gasification gas is heated using a heat exchanger using waste heat from the gasification furnace as a heating source so as to obtain high-temperature reducing gas, which is supplied into the high-temperature steam electrolysis apparatus. Meanwhile, high-temperature steam is manufactured using a heat exchanger using waste heat from the gasification furnace, and this steam is supplied into the high-temperature steam electrolysis apparatus, whereby high-purity hydrogen for fuel cells is manufactured.

Note that the high-temperature steam may be used as a drying source for the forestry biomass, or may be supplied to a steam turbine so as to generate power.

Note also that as the electrical power supplied to the hydrogen producing apparatus, general electrical power may be used, or electrical power generated in the facility in which the hydrogen producing apparatus is installed may be used.

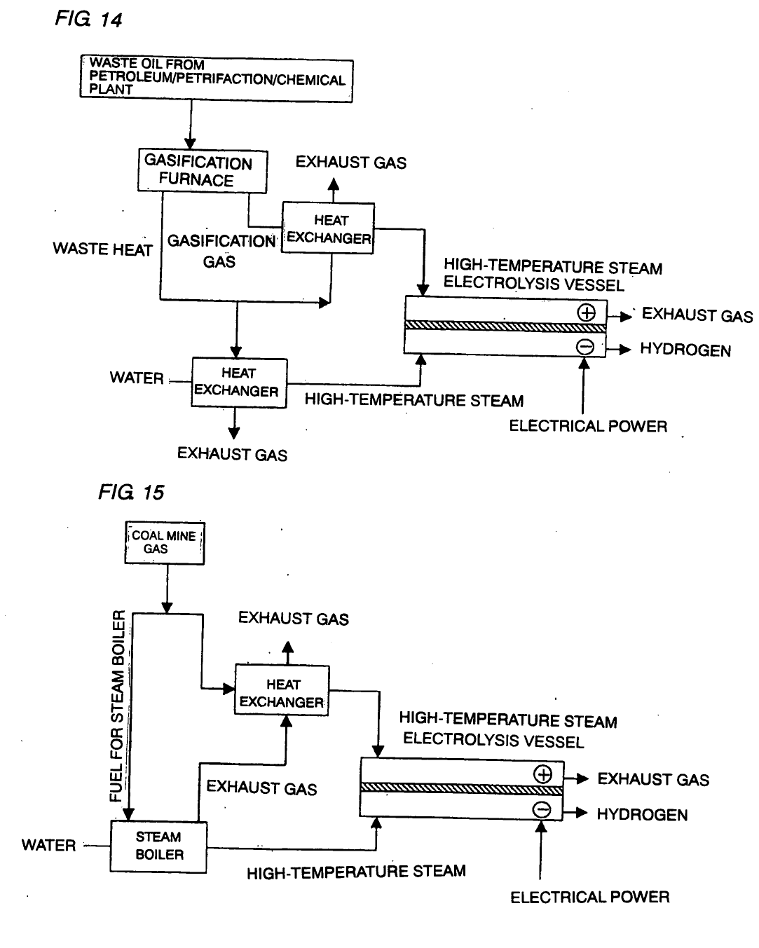

FIG. 14 shows a specific example in which, using a hydrogen producing system according to the present invention, waste oil or the like discharged from a petroleum/petrifaction/chemical plant is treated in a gasification furnace to manufacture gasification gas, this is taken as the reducing gas and supplied into the high-temperature steam electrolysis apparatus, and high-purity hydrogen for fuel cells is manufactured.

The waste oil from the petroleum/petrifaction/chemical plant is treated in the gasification furnace so as to obtain the gasification gas. The manufactured gasification gas is heated using a heat exchanger using waste heat from the gasification furnace as a heating source to obtain high-temperature reducing gas, which is supplied into the high-temperature steam electrolysis apparatus. Meanwhile, high-temperature steam is manufactured using a heat exchanger using waste heat from the gasification furnace, and the manufactured steam is supplied into the high-temperature steam electrolysis apparatus, whereby high-purity hydrogen for fuel cells is manufactured.

Note that the high-temperature steam may also be used in any of various uses in the petroleum/petrifaction/chemical plant, or may be supplied to a steam turbine so as to generate power.

Note also that the electrical power supplied to the high-temperature steam electrolysis apparatus may be general electrical power, or electrical power generated in the petroleum/petrifaction/chemical plant may be used.

FIG. 15 shows a specific example in which, using a hydrogen producing system according to the present invention, coal mine gas (coal mine methane, coal bed methane) is used as the reducing gas, and high-temperature steam is produced using a steam boiler or the like using the coal mine methane as a fuel and is supplied in, whereby high-purity hydrogen for fuel cells is manufactured.

Some of the methane gas-containing coal mine gas discharged from a disused coal mine or the like is supplied as fuel to the steam boiler, and the remainder of the coal mine gas is heated via a heat exchanger using waste heat from the steam boiler to obtain high-temperature reducing gas, which is supplied into the high-temperature steam electrolysis apparatus. Meanwhile, the high-temperature steam manufactured in the steam boiler is supplied into the high-temperature steam electrolysis apparatus, whereby high-purity hydrogen for fuel cells is manufactured.

Note that the high-temperature steam may also be supplied from outside, for example steam from a geothermal power plant.

Moreover, the electrical power supplied to the high-temperature steam electrolysis apparatus may be general electrical power, or may be electrical power from a geothermal power plant as above.

FIG. 16 shows a specific example in which, using a hydrogen producing system according to the present invention, heat produced in the system is used in multiple stages or in a composite way, thus improving the heat utilization efficiency.

A reducing gas 501 is subjected to pre-treatment such as desulfurization using gas pre-treatment equipment 502, and is then heated using a heat exchanger 503, and supplied to an anode side of a high-temperature steam electrolysis apparatus 504. Meanwhile, high-temperature steam 505 is supplied to a cathode side of the high-temperature steam electrolysis apparatus 504, and DC electrical power 550 is supplied into the electrolysis apparatus 504, whereby a produced gas 513 of hydrogen and steam, and exhaust gas (off-gas) 512 are obtained. The produced gas 513 of hydrogen and steam is separated by a condenser 520 into hydrogen 514 and condensed water 521, whereby the hydrogen 514 is manufactured.

As the reducing gas 501, gas already at a high temperature can be used.

As the high-temperature steam 506 supplied into the high-temperature steam electrolysis apparatus 504, high-temperature steam 506 supplied from outside, or steam manufactured by heating pure water 507 using heat exchangers in various places in the system as shown in FIG. 16 can be used.

As a heat source for heating the reducing gas 501 or the steam, the exhaust gas 512 which contains residual methane and so on discharged from the high-temperature steam electrolysis apparatus 504 can be combusted together with waste fuel oil 510 or the like in a catalytic combustor 508, and the heat thus produced can be used. A heat transfer medium 505 such as air is passed through the catalytic combustor 508, and then the heated heat transfer medium is passed through the heat exchangers 509 and 503, whereby the steam and the reducing gas can be heated. Moreover, waste heat 540 from a waste treatment facility, a power plant, a heat utilizing facility, a city infrastructure facility, an industrial furnace, a plant, a coal mine facility or the like as described earlier can be supplied into the heat exchanger 509, the heat exchanger 503 and so on, and thus used as a heat source for heating. The heat transfer medium from which heat for heating the reducing gas 501 has been recovered in the heat exchanger 503 can be passed through the catalytic combustor 508 and thus heated again, and then used as a heat source for preheating the heat transfer medium in a heat exchanger 511.

As the pure water 507 for generating the high-temperature steam, the condensed water 521 recovered from the condenser 520 may be used. Furthermore, the condensed water 521 obtained from the condenser 520 can also be heated using heating means so as to manufacture the high-temperature steam 506.

Examples of the reducing gas 501 that can be used in the present invention include methane, digestion gas, gasification gas, and hydrocarbons obtained through gasification using waste oil from a plant or the like as a raw material.

As the DC power source, electrical power from a power plant or the like as described above can be converted into DC, or DC electrical power from such a power plant or the like can be supplied. Electrical power generated within the hydrogen producing apparatus system may of course also be used.

In the hydrogen producing system of the present invention, combustible syngas can be used as the reducing gas, and hence a gas such as petroleum-based gas, coal-based gas, any of various gasification furnace gases, biogas, natural gas, coal mine gas, gas field gas or the like can be used as the reducing gas; by generating the high-temperature steam using waste heat by-produced from such a plant as a heat source, high-purity hydrogen for fuel cells or the like can thus be manufactured readily. As fuel cell powered vehicles become more widespread, there will be demand for large amounts of high-purity hydrogen; according to the present invention, conventional gas as described above can be used as the reducing gas, and hence high-purity hydrogen gas can be manufactured at low cost throughout the country regardless of region, thus further promoting the widespread use of fuel cell powered vehicles, and hence contributing to a reduction in global warming gases.

If the present invention is applied to an ironworks, then by-product gas from the ironworks, for example COG gas from a coke oven, can be used as the reducing gas, and waste heat from, for example, a coke oven in the ironworks can be used to manufacture the high-temperature steam, which is supplied into the high-temperature steam electrolysis apparatus, whereby high-purity hydrogen can be manufactured.

If the present invention is applied to a sewage treatment plant, then digestion gas from the treatment plant can be used as the reducing gas, and waste heat from a waste incineration plant that is, for example, adjacent to the sewage treatment plant can be used as a heat source for generating the steam and heating the reducing gas, whereby high-purity hydrogen can be manufactured; for example, a waste collecting truck or equipment in the treatment plant that uses petrified fuel as fuel can use the produced hydrogen as an alternative fuel.

If the present invention is applied, for example, to a ranch, then using methane fermentation gas from livestock waste or the like and water such as river water as raw materials, high-purity hydrogen can be manufactured in a forested/mountain region, and can be supplied as fuel for fuel cells for agricultural machinery or the like.

Moreover, in a port, it is possible to obtain biogas using marine products as a raw material and thus manufacture high-purity hydrogen gas using the present invention, and supply this high-purity hydrogen gas as fuel for the port or ships.

Moreover, in a forested/mountain region, it is possible to take as a raw material gas produced from a gasification furnace that uses forestry biomass as a raw material, and manufacture high-temperature steam using waste heat from the furnace, and thus supply hydrogen gas for fuel cell powered vehicles or the like in the forested/mountain region.

By using the present invention in a region in which there is a petroleum/petrifaction/chemical plant, for example by decomposing waste oil from the plant into syngas using a gasification furnace and taking this as the reducing gas, and generating high-temperature steam using waste heat from the gasification furnace or the plant, hydrogen gas can be manufactured. The manufactured hydrogen gas can be used for fuel cell powered vehicles, or can be reused in the plant as, for example, raw material hydrogen for hydrogenation gasification.

The high-purity hydrogen manufactured through the present invention can be made into liquefied hydrogen using liquefaction equipment, and supplied into a superconducting pipeline that uses the liquefied hydrogen as a coolant, whereby the liquefied hydrogen can be transported together with low-loss conveyance of electrical power. The transported liquefied hydrogen can be branched off from the superconducting pipeline at freely chosen positions in the pipeline, and supplied to customers either as is as liquefied hydrogen, or else as hydrogen gas via a hydrogen gas producing apparatus that subjects the liquefied hydrogen to heat exchange. Note that in the hydrogen gas producing apparatus that converts the liquefied hydrogen into normal-temperature hydrogen gas, the cold of the liquefied hydrogen is subjected to heat exchange with a coolant such as water, and hence cold water can also be supplied to customers requiring cooling.

Furthermore, a superconducting signal line that also conveys electrical power can be laid, enabling use also as means for transmitting analog or digital signals with low noise.

When the hydrogen producing system according to the present invention is started up, it is preferable to start from warm-up of the system using the high-temperature steam, and then charge in the reducing gas once the temperature in the system including the high-temperature steam electrolysis apparatus has stabilized. Moreover, it is preferable to supply a medium such as water in advance into a condenser that extracts the hydrogen gas from the gas produced from the high-temperature steam electrolysis apparatus, and then charge the reducing gas into the high-temperature steam electrolysis apparatus. In this case, it goes without saying that it is preferable to control the amounts supplied of the reducing gas, the high-temperature steam, and utilities such as DC electrical power supplied into the high-temperature steam electrolysis apparatus such as to optimize the overall hydrogen producing capability of the hydrogen producing system according to the present invention, and thus save energy during operation.

The normal stopping procedure for the hydrogen producing system according to the present invention is preferably to stop the supply of the reducing gas, and then stop the supply of the utilities. Note that after the supply of the reducing gas has been stopped, with an object of reducing the combustible gas concentration in the system, it is preferable to purge out the system with an inert gas such as nitrogen gas, and then once it has been confirmed that the combustible gas concentration has decreased to not more than a predetermined concentration, further scavenge the inside of the system thoroughly with air.

With the hydrogen producing system according to the present invention, because hydrogen gas is handled, it goes without saying that thorough consideration must be given to safety. In particular, in the high-temperature steam electrolysis apparatus in which the high-temperature hydrogen gas is produced, it is preferable to provide a multiplicity of monitoring apparatuses that check for oxidants such as air or oxygen getting in, and moreover use explosion-proof measuring instruments around equipment handling the hydrogen gas, and so on, so as to monitor operation safely.

In the high-temperature steam electrolysis reaction that is the core of the hydrogen producing system according to the present invention, oxygen ions move through the solid electrolyte diaphragm, and hence explosion or the like cannot be envisaged in principle; nevertheless, the supplied and produced gases are combustible gases, and moreover are handled in a high temperature state, and hence if an accident destroying the reactor or the like were to occur, then it would be desirable to carry out emergency shutdown of the supply of the reducing gas and so on so as to cut off the fuel source instantly, and take emergency avoidance such that combustible gas does not leak out of the system. Moreover, compared with other types of hydrogen producing apparatus, the reactor has a small capacity, and hence the capacity of the equipment in the system overall is small; accordingly, if when carrying out the emergency shutdown of the raw material gas, an inert gas such as nitrogen gas is injected into the system immediately so as to replace the combustible raw material, then the safety can be further improved.

Moreover, because fuel such as the hydrogen gas is handled, it goes without saying that, for safety, as in the case of natural gas, it is preferable to use equipment and operational methods for which thorough consideration has been given to the standards conformed to and so on.

In the fourth mode of the present invention, by supplementing some of the electrical energy required for electrolyzing the water with thermal energy, compared with other water electrolysis methods that have required much electrical power hitherto, the electrical power consumption is low and hence the energy efficiency is high. Furthermore, there is the characteristic feature that high-purity hydrogen is manufactured, and hence a reforming apparatus is not required as a stage after the hydrogen producing apparatus, it being possible to manufacture high-purity hydrogen that can be used directly for fuel cells. Moreover, a process in which raw material gas is produced is generally often a process that also produces a heat source, and hence there is also the characteristic feature that the raw material gas and heat or electrical power can be procured through the same gas production process, and hence the hydrogen producing method is economical. Due to being economical and highly efficient, the present invention can be said to be a producing method that will be suitable for mass demand as a hydrogen producing method for our coming society of advanced hydrogen usage.

Furthermore, according to a fifth mode of the present invention, there is provided a method of producing hydrogen by using a solid oxide electrolyte, supplying a reducing gas to an anode side and steam to a cathode side, and applying a voltage to the anode side and the cathode side, so as to react oxygen ions on the anode side with the reducing gas and thus produce an oxygen ion concentration gradient, the hydrogen producing method characterized in that digestion gas produced through methane fermentation of sewage and/or wastewater and/or waste is used as the reducing gas supplied to the anode side.

Conventionally, in a sewage treatment plant or food plant, sludge produced is treated using an anaerobic digestion method (methane fermentation method), so as to produce digestion gas comprising approximately 60% methane and 40% CO₂, whereby the volume of the sludge is reduced; moreover, the digestion gas produced has been used as a fuel for a boiler, or supplied to a gas engine and thus used as a fuel for power generating equipment covering some of the electrical power used in the treatment plant.

These days, organic matter contained in various types of waste such as city sewage or industrial wastewater, or agricultural waste or forestry waste (forestry biomass) is considered to be a very important energy resource, the amount of methane recovered using anaerobic digestion being provisionally calculated to be 9 gigaliters per year in terms of crude oil. The amount of crude oil imported by Japan is approximately 200 gigaliters, and hence the amount of energy recovered through methane is approximately 4.5% of the amount of crude oil imported, and thus it can be seen that this methane is a very large energy source. However, this digestion gas has conventionally been used almost only as a fuel for heating anaerobic digestion tanks, and subsequently has come to be used merely for digestion gas power generation or as an auxiliary fuel for sludge incinerators, and hence cannot be said to have been used effectively.

Meanwhile, a method in which hydrogen is manufactured by electrolyzing water or steam has received attention; of heat produced through this method of producing hydrogen by electrolysis, heat produced at relatively high temperature has been used effectively, but low-temperature waste heat has been disposed of.

In view of the above state of affairs, in the fifth mode of the present invention, it is an object to provide means for attaining both effective use of digestion gas produced through methane fermentation treatment of sewage, wastewater, or any of various types of waste, and effective use of waste heat produced through a hydrogen producing method using electrolysis. Furthermore, it is another object of the present invention to provide a system that effectively uses the hydrogen manufactured through a hydrogen producing method using electrolysis.

As a hydrogen producing method using electrolysis, there has been proposed a high-temperature steam electrolysis method in which steam is electrolyzed at a high temperature of approximately 800° C., and thermal energy is used in the decomposition of the water, whereby the electrolysis voltage can be reduced and hence the electrical power for the electrolysis can be reduced. However, even with this method, at least 60% of the energy for decomposing the water must still be made up with electrical power. As a proposal for improving this high-temperature steam electrolysis method, in U.S. Pat. No. 6,051,125, there is proposed a method in which natural gas is supplied to the anode of an electrolysis vessel, so as to reduce the electrolysis voltage required for movement of oxygen to the anode side; however, this method has the drawback that expensive natural gas is consumed, and moreover measures for preventing electrode soiling due to carbon deposited through reaction between the natural gas and oxygen are required, and hence there are problems in practice.

As means for solving these problems, the group of the present inventors has previously focused on facts such as (1) pyrolysis gas from biomass such as waste wood or garbage is a reducing gas having hydrogen and carbon monoxide as principal components thereof, (2) by supplying a reducing gas as in (1) to the anode side of a high-temperature steam electrolysis vessel and reacting with oxygen ions on the anode side, the electrolysis voltage can be greatly reduced, and (3) in oxidation of a reducing gas as in (1) having hydrogen and carbon monoxide as principal components thereof, carbon is not deposited and hence there is no risk of electrode soiling, and have proposed a hydrogen producing apparatus in which such a reducing gas is supplied to the anode side of a high-temperature steam electrolysis vessel so as to reduce the electrolysis voltage, and applied for a patent (Japanese Patent Application No. 2002-249754). With the invention proposed in that patent application, when producing hydrogen by electrolyzing steam using a high-temperature steam electrolysis vessel in which a solid oxide electrolyte is used as a diaphragm, and the diaphragm is disposed in the electrolysis vessel so as to partition the electrolysis vessel into an anode side and a cathode side, high-temperature steam is supplied to the cathode side of the electrolysis vessel, and a reducing gas is supplied to the anode side of the electrolysis vessel, thus reacting together oxygen ions and the reducing gas on the anode side of the electrolysis vessel, whereby an oxygen ion concentration gradient is produced, and hence the voltage required for movement of oxygen to the anode side is reduced. With this apparatus, through the steam being decomposed at a high temperature of 700 to 800° C., and the oxygen concentration gradient being produced on the anode side, high-purity hydrogen can be manufactured very efficiently. Note that “reducing gas” here means a gas that can react with oxygen that passes through the solid oxide electrolyte membrane in the steam electrolysis vessel to the anode side of the electrolysis vessel so as to reduce the oxygen concentration on the anode side.

The present inventors have discovered that digestion gas produced through methane fermentation treatment of sewage, wastewater, or any of various types of waste can be used as the reducing gas supplied to the anode side of the electrolysis vessel of such a high-temperature steam electrolysis apparatus, and moreover waste heat produced by the electrolysis apparatus can be used as a heat source required in the methane fermentation treatment.

That is, the fifth mode of the present invention relates to a hydrogen producing method in which a solid oxide electrolyte is used, a reducing gas is supplied to an anode side and steam is supplied to a cathode side, and a voltage is applied to the anode side and the cathode side, so as to react oxygen ions on the anode side with the reducing gas and thus produce an oxygen ion concentration gradient, the hydrogen producing method characterized in that digestion gas produced through methane fermentation of sewage and/or wastewater and/or waste is used as the reducing gas supplied to the anode side.

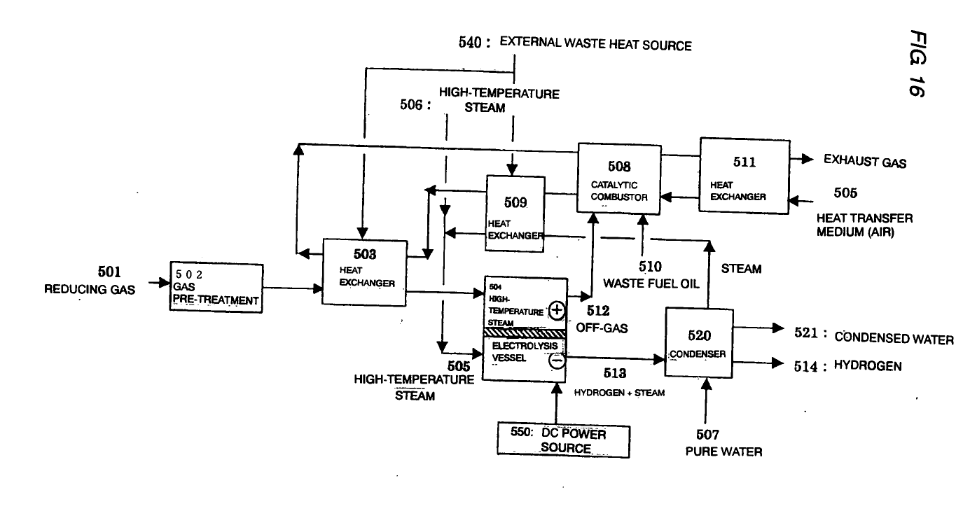

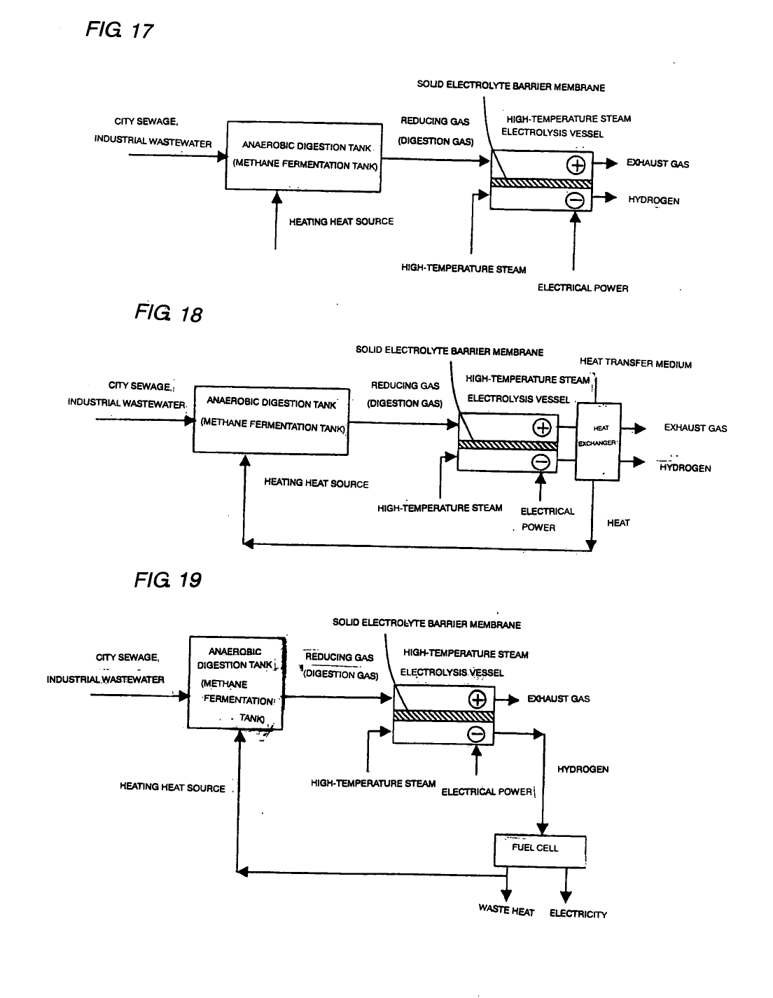

That is, the fifth mode of the present invention is characterized in that, in the case of a hydrogen producing system using high-temperature steam electrolysis using a solid oxide electrolyte membrane as shown in FIG. 2, digestion gas produced through anaerobic digestion (methane fermentation) treatment of sewage, wastewater, or any of various types of waste is used as the reducing gas supplied to the anode side of the high-temperature steam electrolysis vessel. The flow of a specific example of the hydrogen producing method according to the fifth mode of the present invention is shown in FIG. 17.

In the system shown in FIG. 17, city sewage or wastewater (household wastewater, industrial wastewater etc.) is subjected to anaerobic treatment using an anaerobic digestion tank (methane fermentation tank), thus producing a reducing gas (digestion gas). Note that a certain amount of heat is required for the anaerobic digestion, and this heat is supplied by a heating heat source. The produced digestion gas is supplied to the anode side of the high-temperature steam electrolysis vessel described above, high-temperature steam is supplied to the cathode side of the electrolysis vessel, and electrical power is supplied in so as to electrolyze the high-temperature steam. High-temperature exhaust gas is produced from the anode side, and high-temperature hydrogen-containing gas (containing hydrogen and steam) is produced from the cathode side.

Note that in FIG. 17 and the following figures, description is given taking an anaerobic digestion treatment tank for city sewage, wastewater or the like as a representative example of the methane fermentation digestion gas supply source, but it is also possible to use as the methane fermentation digestion gas supply source in the method of the present invention, for example, a methane fermentation tank for sewage installed in a sewage treatment plant, a methane fermentation tank for carrying out fermentation treatment on agricultural waste from a farm, a ranch or the like, a methane fermentation tank for carrying out fermentation treatment on forestry waste (forestry biomass) discharged from a forestry-related industry, or a methane fermentation tank that carries out methane fermentation treatment on any of various other types of waste so as to treat the waste and produce methane.

Note also that as anaerobic digestion there are medium-temperature fermentation and high-temperature fermentation, a temperature of approximately 37° C. or approximately 55° C. respectively being required. Meanwhile, high-temperature exhaust gas and hydrogen-containing gas at approximately 700 to 800° C. are produced from the steam electrolysis vessel. It is thus possible to recover this heat (waste heat from the electrolysis) through a heat recovery system using a heat transfer medium (e.g. air etc.) and a heat exchanger, and use this as a heat source for heating the anaerobic digestion tank as shown in FIG. 18. As the heat source for heating the anaerobic digestion, so long as there is waste heat at least approximately 50 to 70° C. as described above, this is sufficient. It is thus preferable to recover the heat in the high-temperature exhaust gas and hydrogen-containing gas from the steam electrolysis vessel (high-temperature part) through several stages of heat recovery, and after using this recovered heat, then use the low-temperature waste heat as the heat source for heating the anaerobic digestion tank.

The hydrogen manufactured using the above method can be used, for example, as fuel for a fuel cell. Here, fuel cells can be broadly classified into four types, but even with a solid polymer type fuel cell which has the lowest operating temperature, waste heat at approximately 60 to 70° C. can be extracted. Accordingly, as shown in FIG. 19, it is possible to use the hydrogen produced by the high-temperature steam electrolysis vessel as fuel for a fuel cell so as to generate electrical power, and also use at least some of the waste heat produced by the fuel cell as the heat source for heating the anaerobic digestion tank.

Note that it has been rare for hydrogen produced through a hydrogen producing method using electrolysis to be used as fuel for a fuel cell in power generation. One reason for this is that rather than using hydrogen produced using electrical power through an electrolysis method in a power generating apparatus that uses hydrogen as a fuel such as a fuel cell so as to generate power, using the required electrical power as is of course gives more efficient use of the electrical power. However, if hydrogen can be stored efficiently once manufactured, then it is possible to manufacture and store hydrogen when there is an abundance of electrical power or the unit price of electrical power is low, and then when a large amount of electrical power is required, obtain the required electrical power through fuel cell power generation using the stored hydrogen as the fuel for the fuel cell. Currently, some storage of electrical power is carried out using secondary cells such as NAS cells, but looking toward the hydrogen energy society that it is thought will come in the future, it is desired to provide methods for storing hydrogen which has high utilization value.

Among hydrogen storage techniques, methods in which the hydrogen is stored chemically using an organic hydride, a hydrogen occluding alloy or the like have attracted attention. However, heat has been required both to store hydrogen using this method and to release the stored hydrogen; the current state of affairs is that high-temperature vapor manufactured using separate equipment is used as the heat source, an effective heat utilization system integrating all of hydrogen manufacture, hydrogen storage, and hydrogen use not having been created.

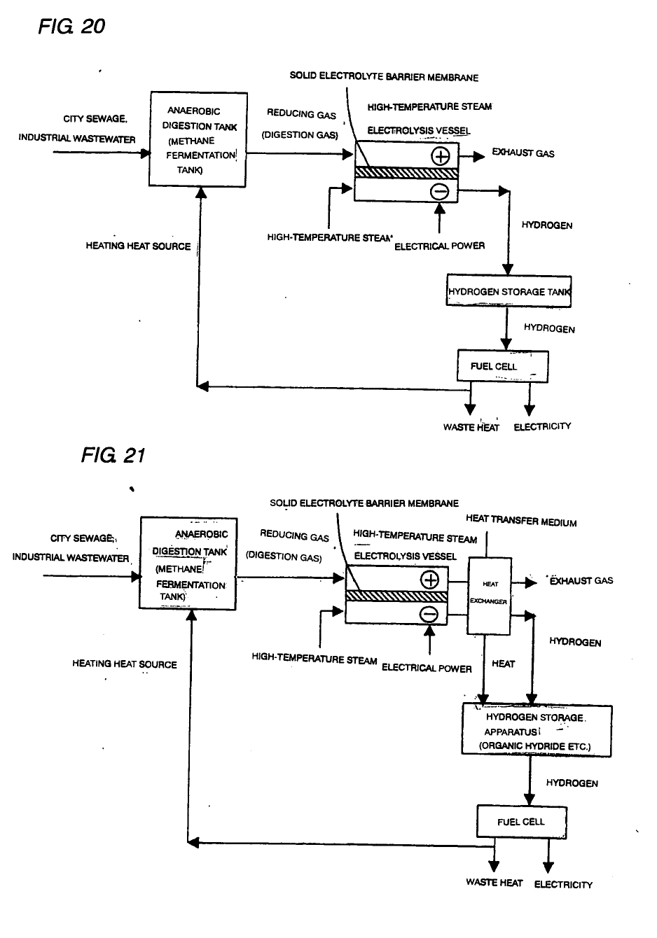

In another mode of the present invention, as shown in FIG. 20, there is provided a power generation method in which hydrogen manufactured using the hydrogen producing method described above is first stored in a hydrogen storage apparatus, and then when required the hydrogen is released from the storage apparatus and used as fuel for a fuel cell. By first storing the manufactured hydrogen, and then when a large amount of electrical power is required, releasing the stored hydrogen and using the hydrogen as fuel for a fuel cell to generate power in this way, for example, hydrogen can be manufactured and stored when the unit price of electrical power is low such as at nighttime, and then when required this hydrogen can be used to generate power, whereby effective utilization of energy can be achieved. Moreover, as shown in FIG. 20, at least some of waste heat produced by the fuel cell can be used as a heat source for heating the anaerobic digestion tank.

As the method of storing the hydrogen, any of various methods publicly known in the technical field in question such as a method using compression or a method using liquefaction can be used. Moreover, methods in which the hydrogen is stored chemically using a hydrogen occluding alloy or an organic hydride have been proposed. In such a hydrogen storage method, the hydrogenation reaction when storing the hydrogen and the dehydrogenation reaction when using the stored hydrogen require heat. According to another mode of the present invention, as shown in FIG. 21, as the heat required for the hydrogenation and dehydrogenation, waste heat from the high-temperature steam electrolysis vessel described above (heat in the high-temperature exhaust gas and high-temperature hydrogen-containing gas) can be recovered using a heat recovery system using a heat transfer medium (e.g. air etc.) and a heat exchanger, and used. An example of a hydrogen storage method that can be used in the present invention is an organic hydride method using cyclohexane, decalin or the like; for this, heat of approximately 100 to 200° C. is required for the hydrogenation and dehydrogenation reactions. Exhaust gas and hydrogen-containing gas at 700 to 800° C. are produced from the high-temperature steam electrolysis vessel according to the present invention, and hence it is possible to recover this heat through several stages of heat recovery, and after using this recovered heat, then use the low-temperature waste heat as the heat source required in the hydrogen storage method.

According to the fifth mode of the present invention, digestion gas produced through anaerobic digestion treatment on wastewater or the like, heat produced when producing hydrogen using the high-temperature steam electrolysis method, and waste heat produced when carrying out fuel cell power generation using the manufactured hydrogen can be used very effectively, and hence the effective utilization of energy can be achieved. Moreover, according to another mode of the present invention, the manufactured hydrogen can be used effectively as required, greatly contributing to effective utilization of energy.

Furthermore, according to a sixth mode of the present invention, there is provided a hydrogen producing method in which a solid oxide electrolyte is used, a reducing gas is supplied to an anode side, high-temperature steam is supplied to a cathode side, and oxygen ions on the anode side are reacted with the reducing gas so as to produce an oxygen ion concentration gradient and thus reduce the electrolysis voltage, the hydrogen producing method characterized in that the reducing gas is supplied to the anode side after having been treated with a sulfur removing apparatus.

As described above, according to the present invention, there is provided a system for producing hydrogen by supplying steam to a cathode side and supplying a reducing high-temperature gas to an anode side of a high-temperature steam electrolysis apparatus in which an electrolysis vessel is partitioned into the anode side and the cathode side using a solid oxide electrolyte as a diaphragm, and carrying out steam electrolysis at high temperature. Here, “reducing gas” means a gas that can react with oxygen that passes through the solid oxide electrolyte membrane in the steam electrolysis vessel to the anode side of the electrolysis vessel so as to reduce the oxygen concentration on the anode side; there can be used pyrolysis gas produced at a waste treatment facility such as an incinerator, a gasification-melting furnace or a gasification furnace, exhaust gas or by-product gas from an ironworks, a plant, a thermoelectric power plant, a geothermal power plant or the like, anaerobic digestion gas from a sewage treatment plant, or the like.

However, the above types of reducing gas often contain a high concentration of sulfur. For example, digestion gas (biogas) from methane fermentation of wastewater or the like, gas produced through pyrolysis in a gasification furnace, and so on contain several hundred ppm of sulfur. In the hydrogen producing method described above in which the reducing gas is supplied to the anode side of the electrolysis vessel, there has thus been a problem that the performance of the electrolysis apparatus progressively decreases due to the sulfur content of the supplied reducing gas. It is an object of the present invention to solve this problem, and provide means for markedly improving the durability of a hydrogen producing apparatus using high-temperature steam electrolysis.

In the sixth mode of the present invention, as means for solving the above problem, there is provided a hydrogen producing method in which a solid oxide electrolyte is used, a reducing gas is supplied to an anode side, high-temperature steam is supplied to a cathode side, and oxygen ions on the anode side are reacted with the reducing gas so as to produce an oxygen ion concentration gradient and thus reduce the electrolysis voltage, the hydrogen producing method characterized in that the reducing gas is supplied to the anode side after having been treated with a sulfur removing apparatus. Furthermore, through the studies of the present inventors, it has been discovered that the operational performance of the electrolysis apparatus is markedly improved by making the sulfur concentration in the reducing gas supplied to the anode side of the electrolysis vessel be not more than 1 ppm, more preferably not more than 0.1 ppm. That is, another mode of the present invention relates to a hydrogen producing method as described above, characterized in that the reducing gas is supplied to the anode side after the sulfur content therein has been made to be not more than 1 ppm, more preferably not more than 0.1 ppm, using the sulfur removing apparatus.

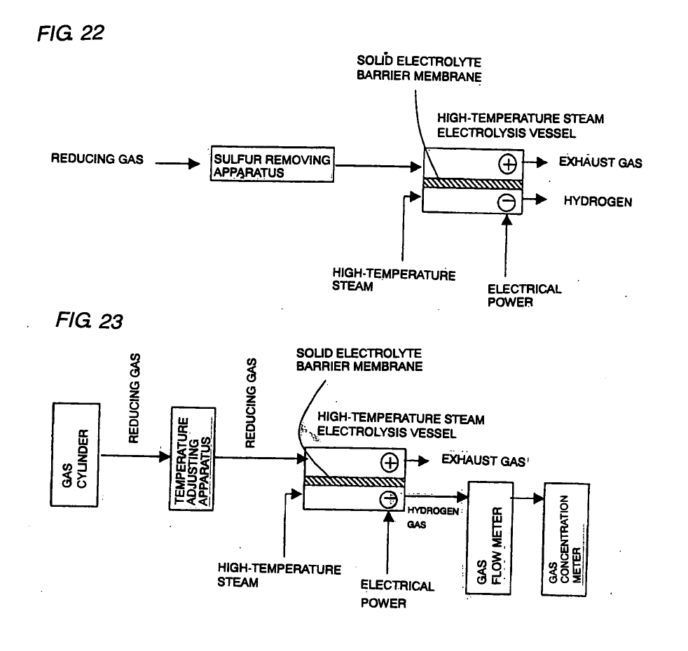

The sixth mode of the present invention is characterized in that the reducing gas supplied to the anode side of a high-temperature steam electrolysis apparatus as shown in FIG. 2 is supplied into the electrolysis apparatus after having been treated with a sulfur removing apparatus. The flow of a hydrogen producing apparatus according to such a mode of the present invention is shown in FIG. 22. With the apparatus shown in FIG. 22, a reducing gas such as gas produced through pyrolysis in a gasification furnace or anaerobic digestion gas from a sewage treatment plant first has the sulfur content therein reduced using a sulfur removing apparatus, and is then supplied to the anode side of the high-temperature steam electrolysis vessel. High-temperature steam is supplied to the cathode side of the electrolysis vessel, and electrical power is applied to the two electrodes, whereby the steam is electrolyzed, and hence gas containing produced hydrogen is produced from the cathode side, and exhaust gas is produced from the anode side of the electrolysis vessel.

In the method of the present invention, as the sulfur removing apparatus, a gas-passing apparatus having incorporated therein activated charcoal, iron, nickel, an alloy having iron and nickel as principal components thereof, a metal-supporting material in which iron and nickel are supported on alumina, a copper-zinc type desulfurizing material, or a copper-zinc-aluminum type desulfurizing material as a sulfur removing material can be used. These sulfur removing materials can be used in the form, for example, of a honeycomb packing material in the case of a metallic material or an alloy material, or in the form of granules or porous particles in the case of a metal-supporting material, a copper-zinc type desulfurizing material, a copper-zinc-aluminum type desulfurizing material or the like. Specifically, for example such a sulfur removing material having the form of granules or porous particles is packed into a gas column, and the reducing gas is passed therethrough, whereby sulfur in the reducing gas can be removed. Adopting this technique is preferable, since the sulfur content can be removed and the reducing gas can be supplied into the high-temperature steam electrolysis vessel without excessively reducing the temperature of the reducing gas.

A copper-zinc type desulfurizing material that can be used as the sulfur removing material in the present invention can be formed, for example, by using an aqueous solution containing a copper compound (e.g. copper nitrate, copper acetate, etc.) and a zinc compound (e.g. zinc nitrate, zinc acetate, etc.) and an aqueous solution of an alkaline substance (e.g. sodium carbonate, potassium carbonate, etc.), bringing about precipitation using an ordinary coprecipitation method, drying the precipitate produced, baking at approximately 300° C., so as to obtain a copper oxide-zinc oxide mixture, and then carrying out reduction treatment at approximately 150 to 300° C. under the presence of hydrogen gas diluted with an inert gas. Moreover, the copper-zinc type desulfurizing material obtained can be mixed with another metal oxide such as chromium oxide as a carrier component.

Moreover, a copper-zinc-aluminum type desulfurizing material that can be used as the sulfur removing material in the present invention can be formed, for example, by using an aqueous solution containing a copper compound (e.g. copper nitrate, copper acetate, etc.), a zinc compound (e.g. zinc nitrate, zinc acetate, etc.) and an aluminum compound (e.g. aluminum nitrate, sodium aluminate, etc.) and an aqueous solution of an alkaline substance (e.g. sodium carbonate, potassium carbonate, etc.), bringing about precipitation using an ordinary coprecipitation method, drying the precipitate produced, baking at approximately 300° C., so as to obtain a copper oxide-zinc oxide-aluminum oxide mixture, and then carrying out reduction treatment at approximately 150 to 300° C. under the presence of hydrogen gas diluted with an inert gas. Moreover, the copper-zinc type desulfurizing material obtained can be mixed with another metal oxide such as chromium oxide as a carrier component.

Note that as described above, the reducing gas is preferably supplied to the anode side of the high-temperature steam electrolysis apparatus after the sulfur content in the reducing gas has been made to be not more than 1 ppm, preferably not more than 0.1 ppm, using the method of the present invention. Through the studies of the present inventors, it has been found that the durability of the electrolysis apparatus can be improved markedly by making the sulfur concentration in the reducing gas supplied to the anode side of the electrolysis apparatus be not more than such a value.

According to the sixth mode of the present invention, hydrogen can be manufactured more economically, and there can be provided high-purity hydrogen gas manufactured through the present invention in industry that manufactures chemical products industrially using hydrogen. Moreover, the high-purity hydrogen gas manufactured through the present invention can be used as fuel used for fuel cells. Furthermore, as fuel cell powered vehicles become more widespread, there will be demand for large amounts of high-purity hydrogen; according to the present invention, high-purity hydrogen gas can be manufactured at low cost throughout the country regardless of region, thus further promoting the widespread use of fuel cell powered vehicles.

### WORKING EXAMPLES

It is shown through the following working examples that by making the sulfur concentration in reducing gas supplied to the anode side of a high-temperature steam electrolysis apparatus be not more than 1 ppm, preferably not more than 0.1 ppm, the durability of the electrolysis apparatus can be markedly improved.

Following the flow shown in FIG. 23, methane gas having sulfur concentration adjusted to 100 ppm, 10 ppm, 1 ppm, or 0.1 ppm from a gas cylinder had the temperature thereof adjusted to approximately 700° C. using a temperature adjusting apparatus, and was then supplied to an anode side of a high-temperature steam electrolysis vessel in which the electrolysis vessel was partitioned into the anode side and a cathode side by a solid oxide electrolyte diaphragm, while high-temperature steam at approximately 700° C. was supplied to the cathode side, and electrical power was applied to the electrodes so as to electrolyze the steam. Yttrium-stabilized zirconia (YSZ) was used as the solid oxide electrolyte.

The electrolysis vessel was operated continuously, while passing hydrogen-containing gas produced from the cathode side of the electrolysis vessel through a flow meter and a gas concentration meter, so as to measure the flow rate and the hydrogen gas concentration.

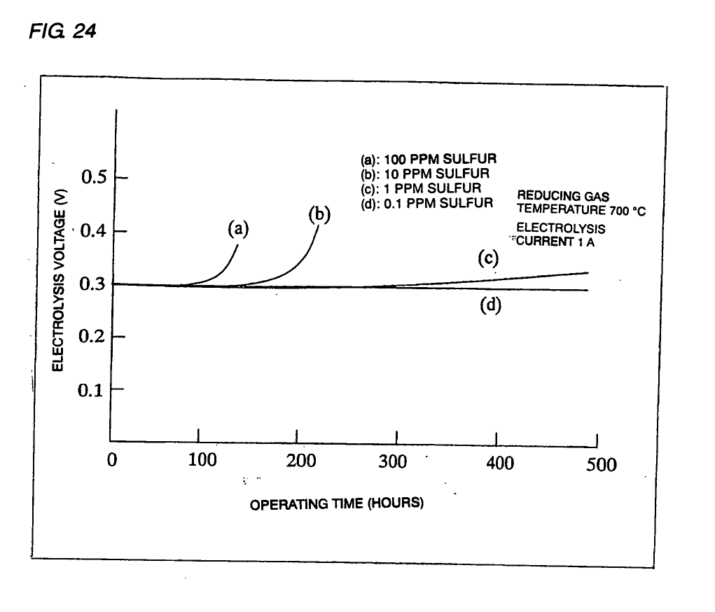

Changes in the electrolysis voltage in the electrolysis apparatus are shown in FIG. 24. In the case that the sulfur concentration in the reducing gas supplied to the anode side of the electrolysis vessel was 100 ppm or 10 ppm, the electrolysis voltage rose suddenly at an operating time of approximately 100 hours or 200 hours respectively, operation being stopped at this time. In the case that the sulfur concentration in the reducing gas was 1 ppm or 0.1 ppm, the electrolysis voltage was stable, not changing from the initial voltage even beyond 300 hours, and gas containing hydrogen at a high concentration was obtained at a stable flow rate. The electrolysis voltage rising means that a higher voltage is required, and hence the performance of the electrolysis apparatus is reduced. From FIG. 24, it can be seen that in the case that the sulfur concentration in the reducing gas supplied to the anode side of the electrolysis vessel is not more than 1 ppm, more preferably not more than 0.1 ppm, the durability of the high-temperature steam electrolysis apparatus was markedly improved.

Various modes of the present invention are as follows.

1. A method of producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte membrane as a diaphragm, and carrying out steam electrolysis at high temperature, the hydrogen producing method characterized in that the reducing gas and the steam supplied into the electrolysis vessel are made to have a temperature in a range of 200 to 500° C.

2. The hydrogen producing method according to above item 1, characterized in that the reducing gas and the steam supplied are heated to a temperature in a range of 200 to 500° C. by carrying out heat exchange with high-temperature offgas and high-temperature hydrogen discharged from the electrolysis vessel.

3. The hydrogen producing method according to above item 1, characterized in that the reducing gas and the steam supplied are heated to a temperature in a range of 200 to 500° C. by carrying out heat exchange with waste heat from another process.

4. The hydrogen producing method according to above item 1, characterized in that the supplied reducing gas is heated to a temperature in a range of 200 to 500° C. by adding high-temperature gas thereto.

5. The hydrogen producing method according to above item 1 or 4, characterized in that the supplied reducing gas or mixed gas of the reducing gas and high-temperature gas, and the steam are heated to a temperature in a range of 200 to 500° C. by carrying out heat exchange with high-temperature offgas and high-temperature hydrogen discharged from the electrolysis vessel.

6. The hydrogen producing method according to above item 1 or 4, characterized in that the supplied reducing gas or mixed gas of the reducing gas and high-temperature gas is heated to a temperature in a range of 200 to 500° C. by carrying out heat exchange with waste heat from another process.

7. The hydrogen producing method according to any of above items 1 to 6, characterized by operating with an electrolysis voltage in a range of 20 to 40% of a required energy.

8. The hydrogen producing method according to any of above items 1 to 7, characterized in that a concentration of hydrochloric acid and/or sulfur compounds in the supplied reducing gas is made to be not more than 10 ppm.

9. The hydrogen producing method according to any of above items 1 to 8, characterized in that the supplied reducing gas is a reducing gas produced through pyrolysis of organic matter, and is cleaned/de-dusted using a scrubber or the like.

10. The hydrogen producing method according to any of above items 1 to 8, characterized in that the supplied reducing gas is by-product gas produced by a coke oven or a blast furnace of an ironworks.

11. The hydrogen producing method according to any of above items 1 to 8, characterized in that the supplied reducing gas is by-product gas from a petroleum plant.

12. The hydrogen producing method according to above item 9, characterized in that the pyrolysis raw material organic matter is biomass such as waste wood or garbage, and petroleum residue.

13. A hydrogen producing apparatus comprising an electrolysis vessel partitioned into an anode side and a cathode side by a solid oxide electrolyte diaphragm, a pipeline supplying a reducing gas to the anode side of the electrolysis vessel, and a pipeline supplying steam to the cathode side of the electrolysis vessel, and characterized by further comprising means for heating the reducing gas and the steam supplied into the electrolysis vessel to a temperature in a range of 200 to 500° C.

14. The hydrogen producing apparatus according to above item 13, characterized in that a flow control valve is provided in each of the pipeline supplying the reducing gas to the anode side of the electrolysis vessel, and the pipeline supplying the steam to the cathode side of the electrolysis vessel, so as to optimally control operating conditions.

15. The hydrogen producing apparatus according to above item 14, characterized in that a temperature gauge is provided in a gas outlet line on the anode side and the cathode side of the electrolysis vessel, and the flow control valves are controlled so as to obtain a constant temperature.

16. A method of producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the high-purity hydrogen producing method characterized in that some of steam from a nuclear power plant vapor generator is used directly as the steam supplied to the cathode side.

17. The hydrogen producing method according to above item 16, characterized in that impurities such as ammonia or hydrazine contained in the produced hydrogen gas are removed using a scrubber or the like.

18. The hydrogen producing method according to above item 16 or 17, characterized in that pyrolysis gas produced using a pyrolysis furnace installed in the nuclear power plant using as a raw material biomass such as waste wood or garbage collected in the power plant or from the surrounding local area, or marine life collected using a screen or the like at a water intake or from the fishery industry is used as the reducing gas supplied to the anode side, and the pyrolysis gas is cleaned/de-dusted using a scrubber or the like, so as to make the concentration of hydrochloric acid and/or sulfur compounds be not more than 10 ppm.

19. The hydrogen producing method according to any of above items 16 to 18, characterized in that the amount of steam supplied into the hydrogen producing apparatus from the nuclear power plant vapor generator is controlled, whereby the electrical power output of the nuclear power plant can be controlled, and moreover surplus vapor is used efficiently, so as to produce and store high-purity hydrogen.

20. The hydrogen producing method according to any of above items 16 to 19, characterized in that vapor at 200 to 300° C. produced from a vapor generator of a pressurized water type nuclear power plant is used as the vapor supplied into the hydrogen producing apparatus.

21. The hydrogen producing method according to any of above items 16 to 19, characterized in that vapor at 300 to 500° C. produced from a vapor generator of a fast breeder type nuclear power plant is used as the vapor supplied into the hydrogen producing apparatus.

22. The hydrogen producing method according to any of above items 16 to 19, characterized in that vapor at 500 to 700° C. produced from a vapor generator of a high-temperature gas type nuclear power plant is used as the vapor supplied into the hydrogen producing apparatus.

23. A hydrogen producing apparatus comprising an electrolysis vessel partitioned into an anode side and a cathode side by a solid oxide electrolyte diaphragm, a pipeline supplying a reducing gas to the anode side of the electrolysis vessel, and a pipeline supplying steam to the cathode side of the electrolysis vessel, and characterized in that some of steam from a nuclear power plant vapor generator is used directly as the steam supplied to the cathode side of the electrolysis vessel.

24. The apparatus according to above item 23, characterized by further having means for treating the produced hydrogen gas produced from the cathode side of the electrolysis vessel, so as to remove impurities such as ammonia or hydrazine contained in the produced hydrogen gas.

25. The apparatus according to above item 23 or 24, characterized by further having a pyrolysis furnace that produces the reducing gas by pyrolyzing biomass such as waste wood or garbage, or marine life collected using a screen or the like at a water intake or from the fishery industry, means for treating the reducing gas produced by the pyrolysis furnace so as to make the concentration of hydrochloric acid and/or sulfur compounds be not more than 10 ppm, and a pipeline supplying the reducing gas for which the concentration of hydrochloric acid and/or sulfur compounds has been reduced to the anode side of the electrolysis vessel.

26. A method of producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the high-purity hydrogen producing method characterized in that some of vapor from a nuclear reactor of a boiling water type nuclear power plant is used directly as the steam supplied to the cathode side.

27. The hydrogen producing method according to above item 26, characterized in that pyrolysis gas produced using a pyrolysis furnace installed in the nuclear power plant using as a raw material biomass such as waste wood or garbage collected in the power plant or from the surrounding local area, or marine life collected using a screen or the like at a water intake or from the fishery industry is used as the reducing gas supplied to the anode side, and the pyrolysis gas is cleaned/de-dusted using a scrubber or the like, so as to make the concentration of hydrochloric acid and/or sulfur compounds be not more than 10 ppm.

28. The hydrogen producing method according to above item 26 or 27, characterized in that the amount of steam supplied into the hydrogen producing apparatus from the nuclear reactor of the boiling water type nuclear power plant is controlled, whereby the electrical power output of the boiling water type nuclear power plant can be controlled, and moreover surplus vapor is used efficiently, so as to produce and store high-purity hydrogen.

29. A boiling water type nuclear power system, characterized in that hydrogen gas manufactured using the method according to any of above items 26 to 28 is stored in a hydrogen gas receiving tank installed in a radiation controlled area, and is then injected into a primary cooling system of the boiling water type nuclear reactor so as to prevent stress corrosion cracking of reactor internals in the boiling water type nuclear reactor.

30. A boiling water type nuclear power system, characterized in that hydrogen gas manufactured using the method according to any of above items 26 to 28 is stored in a hydrogen gas receiving tank installed in a radiation controlled area, and is then used as a fuel for an incinerator for miscellaneous radioactive solids produced in the nuclear power plant.

31. A boiling water type nuclear power system, characterized in that hydrogen gas manufactured using the method according to any of above items 26 to 28 is stored in a hydrogen gas receiving tank installed in a radiation controlled area, and is then used as a generator coolant.

32. A hydrogen producing apparatus comprising an electrolysis vessel partitioned into an anode side and a cathode side by a solid oxide electrolyte diaphragm, a pipeline supplying a reducing gas to the anode side of the electrolysis vessel, and a pipeline supplying steam to the cathode side of the electrolysis vessel, and characterized in that some of vapor from a nuclear reactor of a boiling water type nuclear power plant is used directly as the steam supplied to the cathode side of the electrolysis vessel.

33. The apparatus according to above item 32, characterized by further having a pyrolysis furnace that produces the reducing gas by pyrolyzing biomass such as waste wood or garbage, or marine life collected using a screen or the like at a water intake or from the fishery industry, means for treating the reducing gas produced by the pyrolysis furnace so as to make the concentration of hydrochloric acid and/or sulfur compounds be not more than 10 ppm, and a pipeline supplying the reducing gas for which the concentration of hydrochloric acid and/or sulfur compounds has been reduced to the anode side of the electrolysis vessel.

34. A boiling water type nuclear power plant, characterized by comprising a boiling water type nuclear reactor power generation system, the hydrogen producing apparatus according to above item 32 or 33, and means for injecting hydrogen produced by the hydrogen producing apparatus into a primary cooling system of the boiling water type nuclear reactor.

35. A boiling water type nuclear power plant, characterized by comprising a boiling water type nuclear reactor power generation system, an incinerator for miscellaneous radioactive solids, the hydrogen producing apparatus according to above item 32 or 33, and means for supplying hydrogen produced by the hydrogen producing apparatus as fuel for the incinerator.

36. A boiling water type nuclear power plant, characterized by comprising a boiling water type nuclear reactor power generation system, the hydrogen producing apparatus according to above item 32 or 33, and means for supplying hydrogen produced by the hydrogen producing apparatus to a generator cooling system.

37. A system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the hydrogen producing system characterized by having means for heating at least one of the reducing gas supplied to the anode side and the steam supplied to the cathode side.

38. A system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the hydrogen producing system characterized by having means for recovering heat from at least one of high-temperature exhaust gas discharged from the anode side and high-temperature hydrogen-containing gas discharged from the cathode side of the high-temperature steam electrolysis apparatus.

39. A system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the hydrogen producing system characterized by having means for recovering heat from at least one of high-temperature exhaust gas discharged from the anode side and high-temperature hydrogen-containing gas discharged from the cathode side of the high-temperature steam electrolysis apparatus, and means for heating at least one of the reducing gas supplied to the anode side and the steam supplied to the cathode side of the high-temperature steam electrolysis apparatus using the recovered heat.

40. A system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature, the hydrogen producing system characterized by having means for adjusting a temperature of at least one of the reducing gas supplied to the anode side and the steam supplied to the cathode side of the high-temperature steam electrolysis apparatus, and recovering heat from at least one of high-temperature exhaust gas discharged from the anode side and high-temperature hydrogen-containing gas discharged from the cathode side of the high-temperature steam electrolysis apparatus.

41. The hydrogen producing system according to any of above items 37 to 40, wherein some of the reducing gas supplied to the anode side of the high-temperature steam electrolysis apparatus is branched off and combusted, and the remainder of the reducing gas is heated using heat from the combustion and then supplied to the anode side of the high-temperature steam electrolysis apparatus.

42. The hydrogen producing system according to any of above items 37 to 40, characterized in that waste heat produced from a waste treatment facility, a power plant, a heat utilizing facility or a city infrastructure facility, heat from an industrial furnace, heat from a plant, or heat produced from a coal mine facility is used as heat source for heating at least one of the reducing gas supplied to the anode side of the high-temperature steam electrolysis apparatus and the steam.

43. The hydrogen producing system according to any of above items 37 to 40, characterized in that electrical power supplied into the high-temperature steam electrolysis apparatus is supplied from outside.

44. The hydrogen producing system according to any of above items 37 to 40, wherein steam accompanying the manufactured hydrogen gas is recovered as condensed water using a condenser, and the recovered water is used as raw water for producing the high-temperature steam supplied into the high-temperature steam electrolysis apparatus.

45. The hydrogen producing system according to any of above items 37 to 40, characterized in that exhaust gas discharged from the anode side of the high-temperature steam electrolysis apparatus is combusted, heat from the combustion is recovered using a heat exchanger, and the recovered heat is used as a heating source for at least one of the reducing gas supplied to the anode side and the steam supplied to the cathode side of the high-temperature steam electrolysis apparatus.

46. The hydrogen producing system according to any of above items 37 to 40, characterized in that waste heat from a fuel cell power generating apparatus that uses as fuel hydrogen gas manufactured using the hydrogen producing system is used as a heating source for at least one of the reducing gas supplied to the anode side and the steam supplied to the cathode side of the high-temperature steam electrolysis apparatus.

47. The hydrogen producing system according to any of above items 37 to 40, characterized in that high-temperature hydrogen gas is obtained by removing steam from high-temperature hydrogen-containing gas discharged from the cathode side of the high-temperature steam electrolysis apparatus, and this high-temperature hydrogen gas is subjected to a gas power recovering apparatus so as to recover thermal energy of the high-temperature hydrogen gas as power or electrical power.

48. The hydrogen producing system according to any of above items 37 to 40, characterized in that high-temperature hydrogen-containing gas discharged from the cathode side of the high-temperature steam electrolysis apparatus is supplied to a steam turbine so as to recover thermal energy of the high-temperature hydrogen-containing gas as power or electrical power.

49. A hydrogen producing method in which a solid oxide electrolyte is used, a reducing gas is supplied to an anode side and steam is supplied to a cathode side, and a voltage is applied to the anode side and the cathode side, so as to react oxygen ions on the anode side with the reducing gas and thus produce an oxygen ion concentration gradient, the hydrogen producing method characterized in that digestion gas produced through methane fermentation of sewage and/or wastewater and/or waste is used as the reducing gas supplied to the anode side.

50. The method according to above item 49, wherein at least some of waste heat produced through the hydrogen producing method is used for heating in the methane fermentation, and the digestion gas produced through the methane fermentation is used as the reducing gas supplied to the anode side.

51. The method according to above item 49, wherein hydrogen produced through the hydrogen producing method is supplied to a fuel cell, some of waste heat produced by the fuel cell is used for heating in the methane fermentation, and the digestion gas produced through the methane fermentation is used as the reducing gas supplied to the anode side.

52. A method of generating power using a fuel cell, characterized in that hydrogen produced through the hydrogen producing method according to any of above items 49 to 51 is stored in a hydrogen storage apparatus, and the stored hydrogen is used as fuel for the fuel cell.

53. A method of generating power using a fuel cell in which hydrogen produced through the hydrogen producing method according to any of above items 49 to 51 is stored in a hydrogen storage apparatus that uses a hydrogen storage medium using a hydrogenation reaction and a dehydrogenation reaction, and the stored hydrogen is used as fuel for the fuel cell, the method characterized in that at least some of waste heat produced through the hydrogen producing method is used as a heat source required in the hydrogenation reaction when storing the hydrogen in the hydrogen storage medium or the dehydrogenation reaction when releasing the hydrogen from the storage medium.

54. The method according to above item 53, wherein a hydrogen occluding alloy or an organic hydride is used as the hydrogen storage medium.

55. A hydrogen producing system comprising an electrolysis vessel partitioned into an anode side and a cathode side by a solid oxide electrolyte diaphragm, and a pipeline supplying steam to the cathode side of the electrolysis vessel, and characterized by further comprising a methane fermentation tank for carrying out methane fermentation treatment on sewage and/or wastewater and/or waste, and a pipeline supplying digestion gas produced from the methane fermentation tank to the anode side of the electrolysis vessel.

56. The hydrogen producing system according to above item 55, further comprising means for recovering heat from high-temperature hydrogen-containing gas and/or exhaust gas produced from the electrolysis vessel, and means for supplying at least some of the recovered heat as a heat source for heating the methane fermentation tank.

57. The hydrogen producing system according to above item 55, further comprising a fuel cell, a pipeline supplying hydrogen produced by the hydrogen producing system to the fuel cell, and means for supplying at least some of waste heat produced by the fuel cell as a heat source for heating the methane fermentation tank.

58. A power generation system, characterized by comprising the hydrogen producing system according to any of above items 55 to 57, means for storing hydrogen produced by the hydrogen producing system, a fuel cell, and means for supplying the hydrogen stored by the hydrogen storage means to the fuel cell.

59. The power generation system according to above item 58, wherein a hydrogen storage apparatus that uses a hydrogen storage medium using a hydrogenation reaction and a dehydrogenation reaction is used as the hydrogen storage means, and the power generation system further comprises means for supplying at least some of waste heat produced from the hydrogen producing system as a heat source required in the hydrogenation reaction when storing the hydrogen in the hydrogen storage medium or the dehydrogenation reaction when releasing the hydrogen from the storage medium.

60. A hydrogen producing method in which a solid oxide electrolyte is used, a reducing gas is supplied to an anode side, high-temperature steam is supplied to a cathode side, and oxygen ions on the anode side are reacted with the reducing gas so as to produce an oxygen ion concentration gradient and thus reduce an electrolysis voltage, the hydrogen producing method characterized in that the reducing gas is supplied to the anode side after having been treated with a sulfur removing apparatus.

61. The hydrogen producing method according to above item 60, characterized in that the reducing gas is supplied to the anode side after the sulfur content therein has been made to be not more than 1 ppm, more preferably not more than 0.1 ppm, using the sulfur removing apparatus.

62. The hydrogen producing method according to above item 60 or 61, characterized in that in the sulfur removing apparatus, activated charcoal, iron, nickel, an alloy having iron and nickel as principal components thereof, a metal-supporting material in which iron and nickel are supported on alumina, a copper-zinc type desulfurizing material, or a copper-zinc-aluminum type desulfurizing material is used as a sulfur removing material.

63. A hydrogen producing apparatus comprising an electrolysis vessel partitioned into an anode side and a cathode side by a solid oxide electrolyte diaphragm, a pipeline supplying steam to the cathode side of the electrolysis vessel, and a pipeline supplying a reducing gas to the anode side of the electrolysis vessel, and characterized in that a sulfur removing apparatus is disposed in the pipeline supplying the reducing gas to the anode side of the electrolysis vessel.

64. The hydrogen producing apparatus according to above item 63, characterized in that in the sulfur removing apparatus, activated charcoal, iron, nickel, an alloy having iron and nickel as principal components thereof, a metal-supporting material in which iron and nickel are supported on alumina, a copper-zinc type desulfurizing material, or a copper-zinc-aluminum type desulfurizing material is used as a sulfur removing material.

1. A method of producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte membrane as a diaphragm, and carrying out steam electrolysis at high temperature,
the method being characterized in that the reducing gas and the steam supplied into the electrolysis vessel are made to have a temperature in a range of 200 to 500° C.

2. The method of producing hydrogen according to claim 1, characterized in that the reducing gas and the steam supplied are heated to a temperature in a range of 200 to 500° C. by carrying out heat exchange with high-temperature offgas and high-temperature hydrogen.

3. The method of producing hydrogen according to claim 1, characterized in that the reducing gas and the steam supplied are heated to a temperature in a range of 200 to 500° C. by carrying out heat exchange with waste heat from another process.

4. The method of producing hydrogen according to claim 1, characterized in that the supplied reducing gas is heated to a temperature in a range of 200 to 500° C. by adding high-temperature gas thereto.

5. The method of producing hydrogen according to claim 1, characterized in that the supplied reducing gas or mixed gas of the reducing gas and high-temperature gas, and the steam are heated to a temperature in a range of 200 to 500° C. by carrying out heat exchange with high-temperature offgas and high-temperature hydrogen.

6. The method of producing hydrogen according to claim 1, characterized in that the supplied reducing gas or mixed gas of the reducing gas and high-temperature gas is heated to a temperature in a range of 200 to 500° C. by carrying out heat exchange with waste heat from another process.

7. The method of producing hydrogen according claim 1, characterized by operating with an electrolysis voltage in a range of 20 to 40% of a required energy.

8. The method of producing hydrogen according to claim 1, characterized in that a concentration of hydrochloric acid and/or sulfur compounds in the supplied reducing gas is made to be not more than 10 ppm.

9. The method of producing hydrogen according to claim 1, characterized in that the supplied reducing gas is a reducing gas produced through pyrolysis of organic matter, and is cleaned/de-dusted using a scrubber or the like.

10. The method of producing hydrogen according to claim 1, characterized in that the supplied reducing gas is by-product gas produced by a coke oven or a blast furnace of an ironworks.

11. The method of producing hydrogen according to claim 1, characterized in that the supplied reducing gas is by-product gas from a petroleum plant.

12. The method of producing hydrogen according to claim 9, characterized in that the pyrolysis raw material organic matter is biomass such as waste wood or garbage, and petroleum residue.

13. A hydrogen producing apparatus comprising an electrolysis vessel partitioned into an anode side and a cathode side by a solid oxide electrolyte diaphragm, a pipeline supplying a reducing gas to the anode side of the electrolysis vessel, and a pipeline supplying steam to the cathode side of the electrolysis vessel,
characterized by further comprising means for heating the reducing gas and the steam supplied into the electrolysis vessel to a temperature in a range of 200 to 500° C.

14. The hydrogen producing apparatus according to claim 13, characterized in that a flow control valve is provided in each of the pipeline supplying the reducing gas to the anode side of the electrolysis vessel and the pipeline supplying the steam to the cathode side of the electrolysis vessel, so as to optimally control operating conditions.

15. The hydrogen producing apparatus according to claim 14, characterized in that a temperature gauge is provided in a gas outlet line on the anode side and the cathode side of the electrolysis vessel, and the flow control valves are controlled so as to obtain a constant temperature.

16. A system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature,
the system being characterized by having means for heating at least one of the reducing gas supplied to the anode side and the steam supplied to the cathode side.

17. A system for producing hydrogen by supplying steam to a cathode side and supplying a reducing gas to a cathode side of a high-temperature steam electrolysis apparatus in which an electrolysis vessel is partitioned into the anode side and the cathode side using a solid oxide electrolyte as a diaphragm, and carrying out steam electrolysis at high temperature,
the system being characterized by having means for recovering heat from at least one of high-temperature exhaust gas discharged from the anode side and high-temperature hydrogen-containing gas discharged from the cathode side of the high-temperature steam electrolysis apparatus.

18. A system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature,
the system being characterized by having means for recovering heat from at least one of high-temperature exhaust gas discharged from the anode side and high-temperature hydrogen-containing gas discharged from the cathode side of the high-temperature steam electrolysis apparatus, and means for heating at least one of the reducing gas supplied to the anode side and the steam supplied to the cathode side of the high-temperature steam electrolysis apparatus using the recovered heat.

19. A system for producing hydrogen by supplying steam to a cathode side and supplying a reducing gas to an anode side of a high-temperature steam electrolysis apparatus in which an electrolysis vessel is partitioned into the anode side and the cathode side using a solid oxide electrolyte as a diaphragm, and carrying out steam electrolysis at high temperature,
the system being characterized by having means for adjusting a temperature of at least one of the reducing gas supplied to the anode side and the steam supplied to the cathode side of the high-temperature steam electrolysis apparatus, and recovering heat from at least one of high-temperature exhaust gas discharged from the anode side and high-temperature hydrogen-containing gas discharged from the cathode side of the high-temperature steam electrolysis apparatus.

20. The system for producing hydrogen according to claim 16, wherein some of the reducing gas supplied to the anode side of the high-temperature steam electrolysis apparatus is branched off and combusted, and the remainder of the reducing gas is heated using heat from the combustion and then supplied to the anode side of the high-temperature steam electrolysis apparatus.

21. The system for producing hydrogen according to claim 16, characterized in that waste heat produced from a waste treatment facility, a power plant, a heat utilizing facility or a city infrastructure facility, heat from an industrial furnace, heat from a plant, or heat produced from a coal mine facility is used as heat source for heating at least one of the reducing gas supplied to the anode side of the high-temperature steam electrolysis apparatus and the steam.

22. The system for producing hydrogen according to claim 16, characterized in that electrical power supplied into the high-temperature steam electrolysis apparatus is supplied from outside.

23. The system for producing hydrogen according to claim 16, wherein steam accompanying the manufactured hydrogen gas is recovered as condensed water using a condenser, and the recovered water is used as raw water for producing the high-temperature steam supplied into the high-temperature steam electrolysis apparatus.

24. The system for producing hydrogen according to claim 16, characterized in that exhaust gas discharged from the anode side of the high-temperature steam electrolysis apparatus is combusted, heat from the combustion is recovered using a heat exchanger, and the recovered heat is used as a heating source for at least one of the reducing gas supplied to the anode side and the steam supplied to the cathode side of the high-temperature steam electrolysis apparatus.

25. The system for producing hydrogen according to claim 17, wherein some of the reducing gas supplied to the anode side of the high-temperature steam electrolysis apparatus is branched off and combusted, and the remainder of the reducing gas is heated using heat from the combustion and then supplied to the anode side of the high-temperature steam electrolysis apparatus.

26. The system for producing hydrogen according to claim 18, wherein some of the reducing gas supplied to the anode side of the high-temperature steam electrolysis apparatus is branched off and combusted, and the remainder of the reducing gas is heated using heat from the combustion and then supplied to the anode side of the high-temperature steam electrolysis apparatus.

27. The system for producing hydrogen according to claim 19, wherein some of the reducing gas supplied to the anode side of the high-temperature steam electrolysis apparatus is branched off and combusted, and the remainder of the reducing gas is heated using heat from the combustion and then supplied to the anode side of the high-temperature steam electrolysis apparatus.

28. The system for producing hydrogen according to claim 17, characterized in that waste heat produced from a waste treatment facility, a power plant, a heat utilizing facility or a city infrastructure facility, heat from an industrial furnace, heat from a plant, or heat produced from a coal mine facility is used as heat source for heating at least one of the reducing gas supplied to the anode side of the high-temperature steam electrolysis apparatus and the steam.

29. The system for producing hydrogen according to claim 18, characterized in that waste heat produced from a waste treatment facility, a power plant, a heat utilizing facility or a city infrastructure facility, heat from an industrial furnace, heat from a plant, or heat produced from a coal mine facility is used as heat source for heating at least one of the reducing gas supplied to the anode side of the high-temperature steam electrolysis apparatus and the steam.

30. The system for producing hydrogen according to claim 19, characterized in that waste heat produced from a waste treatment facility, a power plant, a heat utilizing facility or a city infrastructure facility, heat from an industrial furnace, heat from a plant, or heat produced from a coal mine facility is used as heat source for heating at least one of the reducing gas supplied to the anode side of the high-temperature steam electrolysis apparatus and the steam.

31. The system for producing hydrogen according to claim 17, characterized in that electrical power supplied into the high-temperature steam electrolysis apparatus is supplied from outside.

32. The system for producing hydrogen according to claim 18, characterized in that electrical power supplied into the high-temperature steam electrolysis apparatus is supplied from outside.

33. The system for producing hydrogen according to claim 19, characterized in that electrical power supplied into the high-temperature steam electrolysis apparatus is supplied from outside.

34. The system for producing hydrogen according to claim 17, wherein steam accompanying the manufactured hydrogen gas is recovered as condensed water using a condenser, and the recovered water is used as raw water for producing the high-temperature steam supplied into the high-temperature steam electrolysis apparatus.

35. The system for producing hydrogen according to claim 18, wherein steam accompanying the manufactured hydrogen gas is recovered as condensed water using a condenser, and the recovered water is used as raw water for producing the high-temperature steam supplied into the high-temperature steam electrolysis apparatus.

36. The system for producing hydrogen according to claim 19, wherein steam accompanying the manufactured hydrogen gas is recovered as condensed water using a condenser, and the recovered water is used as raw water for producing the high-temperature steam supplied into the high-temperature steam electrolysis apparatus.

37. The system for producing hydrogen according to claim 17, characterized in that exhaust gas discharged from the anode side of the high-temperature steam electrolysis apparatus is combusted, heat from the combustion is recovered using a heat exchanger, and the recovered heat is used as a heating source for at least one of the reducing gas supplied to the anode side and the steam supplied to the cathode side of the high-temperature steam electrolysis apparatus.

38. The system for producing hydrogen according to claim 18, characterized in that exhaust gas discharged from the anode side of the high-temperature steam electrolysis apparatus is combusted, heat from the combustion is recovered using a heat exchanger, and the recovered heat is used as a heating source for at least one of the reducing gas supplied to the anode side and the steam supplied to the cathode side of the high-temperature steam electrolysis apparatus.

39. The system for producing hydrogen according to claim 19, characterized in that exhaust gas discharged from the anode side of the high-temperature steam electrolysis apparatus is combusted, heat from the combustion is recovered using a heat exchanger, and the recovered heat is used as a heating source for at least one of the reducing gas supplied to the anode side and the steam supplied to the cathode side of the high-temperature steam electrolysis apparatus.
